(19) United States
(12) Patent Application Publication
(10) Pub. No.: US 2023/0417063 A1
(43) Pub. Date: Dec. 28, 2023

(54) PROCESS AND ARRANGEMENT FOR MANUFACTURING A BOARD ELEMENT COMPRISING CAVITIES

(71) Applicant: CERALOC INNOVATION AB, Viken (SE)

(72) Inventor: Per Josefsson, RAMLÖSA (SE)

(73) Assignee: CERALOC INNOVATION AB, Viken (SE)

(21) Appl. No.: 18/209,667

(22) Filed: Jun. 14, 2023

(30) Foreign Application Priority Data
Jun. 23, 2022 (SE) 2250776-8
Jun. 23, 2022 (SE) 2250777-6
Jan. 30, 2023 (SE) 2350086-1

(51) Int. Cl. E04F 13/08; B44C 5/04

(52) U.S. Cl. CPC E04F 13/0894; B44C 5/0453

(57) ABSTRACT

A process for manufacturing a board element including at least one cavity in a rear side thereof. The process includes providing a substrate including a thermoplastic material, wherein the substrate includes a substrate portion, and creating the at least one cavity in a rear side of the substrate by impressing the substrate portion by an impression device including at least one protruding impression element, thereby obtaining the board element. The substrate portion is disposed at an elevated temperature (TS) of 40-295° C. when creating the at least one cavity. The process includes creating at least one tapering cavity by means of at least one tapering impression element.

### CROSS REFERENCE TO RELATED APPLICATIONS

The present application claims the benefit of Swedish application no. SE 2250776-8, filed on Jun. 23, 2022, Swedish application no. SE 2250777-6, filed on Jun. 23, 2022, and Swedish application no. SE 2350086-1, filed on Jan. 30, 2023. The entire contents of each of Swedish application no. SE 2250776-8, filed on Jun. 23, 2022, Swedish application no. SE 2250777-6, filed on Jun. 23, 2022, and Swedish application no. SE 2350086-1 are hereby incorporated herein by reference in their entirety.

### TECHNICAL FIELD

The disclosure generally relates to a process for manufacturing a board element comprising at least one cavity, preferably a plurality of cavities, in a rear side of the board element. More specifically, the cavities are created by means of impression. The board element may be formed from a substrate comprising a thermoplastic material. The disclosure also relates to the board element, such as a panel, per se and a related arrangement for manufacturing the board element. The panel may be a building panel, floor panel, wall panel, ceiling panel or furniture component.

### BACKGROUND

The weight of panels, such as floor panels, may be reduced in a variety of ways. WO 2013/032391 and WO 2014/007738 disclose panels comprising a thermoplastic material that are provided with a certain groove structure in their rear sides for decreasing their weight. The groove structure may be formed by removing material from the rear sides, for example with rotating jumping tools or knives. Improved methods of forming such grooves by a processing tool are disclosed, e.g., in WO 2020/180237 and WO 2022/050891.

There may be scenarios in which it is advantageous to form grooves without any removal of material. For example, and as disclosed in WO 2013/032391, the grooves may be formed when the panel is pressed, such as in a discontinuous press, by extrusion as disclosed in WO 2021/018918 or by impression as disclosed in WO 2021/180882. However, as yet, little is known about the specifics of such and similar methods. Furthermore, the resulting properties of panels comprising grooves formed by such and similar methods remain to be explored further. Therefore, there is need for improved methods and equipment for providing such grooves or cavities.

### SUMMARY

It is therefore an object of at least embodiments of the present disclosure to provide a more efficient process for manufacturing a board element comprising cavities.

Another object of at least embodiments of the present disclosure is to provide a more controlled process for creating the cavities.

Yet another object of at least embodiments of the present disclosure is to provide an attachment of a layer to a board element comprising cavities in a more controlled manner.

It is also an object to provide a corresponding an arrangement for manufacturing a board element.

An additional object is to provide a board element or panel comprising at least one cavity in a rear side thereof, optionally manufactured in accordance with embodiments of the process described herein.

These and other objects and advantages that will be apparent from the description have been achieved by the various aspects, embodiments and examples described below.

In accordance with a first aspect of the disclosure, there is provided a process for manufacturing a board element comprising at least one cavity, preferably a plurality of cavities, in a rear side of the board element. The process comprises providing a substrate comprising a thermoplastic material, wherein the substrate comprises a substrate portion, and creating the at least one cavity in a rear side of the substrate by impressing the substrate portion by an impression device comprising at least one protruding impression element, preferably a plurality of protruding impression elements, thereby obtaining the board element.

The cavities may reduce the weight of the board element. In accordance with the first aspect, cavities may be created from a substrate by shaping of the thermoplastic material therein, preferably when the substrate portion is disposed at an elevated temperature. Indeed, by means of the impression, material may be displaced for creating the cavities. In particular, a smaller amount of material, or even no material, may have to be removed from the substrate, such as by a rotating cutting device, for creating the cavities, whereby the process may become more efficient.

The substrate may be hardened or cured for forming at least a part of the board element, preferably a core thereof.

The substrate may be absent of cavities, such as when providing the substrate. Nevertheless, in some embodiments, a pre-shaped substrate may comprise grooves as detailed below.

Throughout the present disclosure, the wording “cavity” may be construed as a recess, groove, depression, notch, indentation, cut, etc. The cavities may be open towards the rear side.

For simplicity of the presentation herein, reference will often be made to a plurality of cavities, a plurality of impression elements, etc., but is it clear to a skilled artisan that at least one cavity, at least one impression element, etc., is included in these statements.

A hardened or cured substrate may provide a core of the board element. Optionally, a decor structure, such as a decorative layer and/or a wear layer, may be attached, such as laminated or adhered, to a front side of the substrate or core. The decorative layer may be a print layer. In some embodiments, a backing layer, such as a balancing layer, may be attached, such as laminated or adhered, to a rear side of the substrate or core.

The thermoplastic material may comprise thermoplastic polymers, such as polyvinyl chloride, PVC, polyethylene, PE, polypropylene, PP, thermoplastic polyurethane, TPU, or polyethylene terephthalate, PET, ethylene-vinyl acetate, EVA, polyamide, PA, polystyrene, PS, polyvinyl acetate, PVAc, polymethyl methacrylate, PMMA, polyvinyl butyral, PVB, polycarbonate, PC, acrylonitrile butadiene styrene, ABS, polyacrylamide, PAM, polybutylene terephthalate, PBT, or chlorinated PVC, CPVC. Generally herein, the thermoplastic material may comprise amorphous polymers and/or semi-crystalline polymers.

The thermoplastic material may comprise a, preferably inorganic or organic, filler. A degree of filler may exceed 40 wt %, preferably exceeding 60 wt %, such as 50-90 wt % or 60-80 wt %.

The filler may comprise, or may be, an inorganic filler, such as a mineral material, for example calcium carbonate (CaCO₃), limestone, such as chalk, talc, fly ash, or a stone material, such as stone powder.

The filler may comprise, or may be, an organic filler, such as a wood material, a bamboo material, cork or rice husks. For example, the wood material may be wood fibres and/or wood dust, and the bamboo material may be bamboo dust.

An amount of thermoplastic polymers, such as PVC, may be 10-40 wt %, such as 15-35 wt %.

The core may be a rigid core. A degree of plasticizer in the core may be less than 5 wt %, preferably less than 3 wt % or less than 1 wt %. The core, such as the rigid core, may have a modulus of elasticity, or Young's modulus E, of 1-10 GPa, such as 2-8 GPa, preferably determined in accordance with ISO 178:2010/A1:2013.

The impression device may comprise at least one roller. Thereby, the substrate may be impressed while the substrate is displaced.

The impression device may comprise an impression press plate provided with a structured surface comprising the at least one protruding impression element. The impression press plate may be provided in a static press or a continuous press.

A first and a second set of impression elements may be separated from each other along a separation direction by a blank portion, wherein a distance between the impression elements along the separation direction between the first and the second sets is larger than a distance between the impression elements within each of the first and the second sets. Thereby, cavities may be created in the board element that are separated by a separation portion. The separation portion may function as a dividing portion of the board element or a strengthening board area. The blank portion may be absent of any impression elements, for example being a smooth surface. However, the blank portion may optionally comprise embossing elements, preferably being smaller than the impression elements, such as being 50%, preferably 70%, more preferably 90%, smaller than the impression elements in height and/or extension. The separation direction may be substantially parallel with the feeding direction at least during a part of an impression cycle. A separation direction of a roller of the impression device may extend along and/or transverse to a rotational direction of the roller.

The substrate portion may be disposed at an elevated temperature when creating the at least one cavity. Thereby, the creation of the cavities may become more controlled and/or the flow of the material when creating the cavities may increase.

The substrate portion, such as the substrate as a whole, may be provided above a glass-transition temperature T g of the thermoplastic material when creating the at least one cavity. Thereby, the thermoplastic material may be provided in a visco-elastic state (rubbery state). When the thermoplastic material comprises semi-crystalline polymers, such as PET, the substrate portion preferably is provided below a melting temperature Tₘ of the thermoplastic material.

The process may further comprise elevating a temperature of the substrate portion from an initial temperature to the elevated temperature. The elevated temperature may be higher than an ambient temperature in which the substrate is provided during the creation of the cavities and/or higher than an initial temperature of the substrate. For example, the ambient temperature may be 13-40° C., such as 16-26° C.

The initial temperature may be a temperature of the substrate that has been acclimatized to the ambient temperature. Alternatively, or additionally, the initial temperature may be a temperature of the substrate before heating of the substrate.

For example, the temperature of the substrate (portion), such as the initial or elevated temperature, may be determined by an infrared thermometer or a thermal imaging camera.

The elevated temperature may be obtained by heating the substrate portion.

Thereby, the substrate portion may be pre-heated before creating the cavities.

The elevated temperature may be obtained during a forming of the substrate under heat and, preferably, pressure. Hence, the heat generated for forming the substrate may be used for simplifying the creation of cavities therein.

The elevated temperature may exceed 40° C., preferably being 40-295° C., more preferably 100-295° C. When the thermoplastic material comprises PVC, and, preferably, a filler, the elevated temperature may be 50-210° C., preferably 60-180° C., more preferably 110-180° C. When the thermoplastic material comprises PP, and, preferably, a filler, the elevated temperature may be 60-220 ° C., preferably 70-175° C., more preferably 100-175° C. When the thermoplastic material comprises PET, and, preferably, a filler, the elevated temperature may be 70-295° C., preferably 110-280° C., more preferably 130-280° C.

The impressing may comprise applying a pressure of 0.4-5.0 MPa to the substrate portion, such as 0.5-4.0 MPa or 0.6-3.0 MPa. For example, the pressure may be a maximal applied pressure.

The process may further comprise forming the substrate under heat, preferably under pressure and/or by (co-)extrusion. By “(co-)extrusion” is throughout the disclosure meant extrusion (single layer) in an extruder or coextrusion (at least two layers) in a co-extruder. Herein, an extruder or a co-extruder may be shortened as “(co-)extruder” or sometimes only “extruder”.

The process may further comprise cooling a front side of the substrate during and/or after creating the at least one cavity. By means of the cooling, a well-defined and uniform front side may be provided while a shrinkage of the thermoplastic material may occur in a lower portion of the substrate, such as the rear side. An inner portion of the at least cavity may constitute a non-functional surface and may function as a compensation area for material that shrinks during the cooling.

The process may further comprise cooling at least a cavity region of the substrate or the board element during and/or after creating the at least one cavity. For example, the cavity region may be cooled from the elevated temperature to a cooling temperature below the elevated temperature. Thereby, a form of the cavities may become more defined, such as being fixed during a shorter time period. Moreover, a dimensional stability of the board element may become improved and, as a consequence, an attachment, such as lamination, of a layer to the board element comprising the cavities may become more controlled. Cooling of the cavity region during the creation of the cavities may be particularly useful when the thermoplastic material comprises semi-crystalline polymers, which may be more prone to warping or deformation, e.g., due to shrinkage of the material during cooling. Generally herein, the cavity region may comprise the substrate portion, or a corresponding board portion obtained after curing or hardening thereof, and/or a section of the created cavities, such as an inner portion thereof or a cavity wall and/or bottom wall thereof, and, preferably, surface sections between the cavities.

When both the front side and the cavity region are cooled, the front side preferably is cooled at a lower temperature than the cavity region.

The cavity region may be cooled to a cooling temperature T_{c} which is within a range of 0.8 to 1.9 of a glass-transition temperature T_{g} of the thermoplastic material. The cooling temperature T_{c} and the glass-transition temperature T_{g} may be specified in Kelvin. The thermoplastic material may comprise amorphous polymers and/or semi-crystalline polymers. For example, the thermoplastic material may comprise PVC, PET, PA, PS or PVAc.

The substrate portion, or even the entire substrate, may be disposed at a substrate forming temperature directly after forming of the substrate. In some embodiments, the cavity region may be cooled below the substrate forming temperature.

Generally, the cavity region may be cooled by at least 20° C., preferably 20-120° C., from the elevated temperature. For example, this cooling may be preferred for semi-crystalline polymers, such as PET. For amorphous polymers, such as PVC, the cavity region may be cooled by at least 30° C., preferably 30-90° C.

In some embodiments, the cavity region may be cooled from the elevated temperature by at least 10° C., preferably 10-100° C., below a melting temperature Tₘ of the thermoplastic material. This cooling may be preferred for semi-crystalline polymers. For example, the thermoplastic material may comprise PP, PE, TPU or EVA.

The process may further comprise attaching a layer to the board element, such as by lamination or by means of an adhesive. The lamination may include pressing the layer to the board element, optionally under heat.

The process may further comprise supporting at least an inner portion of the created at least one cavity during lamination of a layer to the board element and/or during cooling of at least a cavity region of the board element. Alternatively, or additionally, the inner portion may be supported during pressing between rollers.

Similarly to the discussion above, a form of the cavities may thereby become more defined. Also, the lamination may be more controlled, e.g., by reducing a risk of deforming or even destroying the created cavities. Indeed, the pressure applied from the laminating may sometimes cause at least a partial collapse of the cavities. Also, due to a varying pressure distribution in the board element caused by the created cavities, a risk of obtaining discolorations or defects in the layer may be reduced.

The layer may be a decor structure and/or a backing layer.

In some embodiments, a layer may be attached, such as laminated, to the substrate while creating the cavities.

The board element may be cooled after creating the cavities and before lamination of the layer.

The process may further comprise forming at least one chamfer in the at least one cavity, wherein each chamfer is disposed between a cavity wall and the rear side or between the cavity wall and a bottom portion of the cavity.

The process may further comprise creating at least one tapering cavity by means of at least one tapering impression element. Thereby, the at least one protruding impression element may be a tapering impression element, and the tapering impression element may create a tapering cavity. The tapering impression element may provide a draft angle. For example, the tapering impression element may comprise a tapering lateral wall portion and/or a bevel, and the tapering cavity may comprise a tapering cavity wall and/or a chamfer. The material of the substrate may thereby be more easily be released from the impression elements after creating the cavities. Also, the flow of the material when creating the cavities may become better, especially when the substrate portion is disposed at an elevated temperature.

A draft angle between a lateral wall portion of the at least one tapering impression element and an overall normal direction of the impression device may exceed 0.5°, such as exceeding 1.0° or even exceeding 3.0°.

The process may further comprise displacing the substrate in a feeding direction, preferably during the creating of the at least one cavity.

The process may further comprise pre-shaping the substrate before the creating of the at least one cavity, preferably by forming at least one groove. Thereby, the substrate may be provided with at least a part of a final cavity configuration of the board element. Moreover, an expansion area for material that is displaced during the impression may be provided, whereby the creation of cavities may be simplified and/or a control of the displacement of the material during the impression may be improved. For example, the pre-shaping may be obtained by (co-)extrusion.

The cavities may be created after the pre-shaping of the substrate while the substrate portion is disposed at the elevated temperature.

The board element may be provided in the form of a panel or may be dividable into at least one panels, such as at least two panels, wherein each panel is a building panel, floor panel, wall panel, ceiling panel or furniture component. For example, a plank, a slab, and a tile are included as examples of a panel.

The creation of cavities may include transversely displacing material, which may result in a varying width of the substrate. The process may therefore further comprise trimming edge portions of the substrate after creating the cavities. The trimming may provide a more defined width of the board element. Preferably, the edge portions are trimmed while the substrate is disposed at the elevated temperature, such as in accordance with any of the embodiments describe herein. Thereby, an easier trimming may be provided while utilizing the energy used for heating the substrate more efficiently.

The process may further comprise annealing the board element after creating the at least one cavity. By means of the annealing (or “normalization”), internal stresses in the board element, e.g., after the creation of the cavities may be reduced. This may be particularly important at sharp sections or corners of the cavities, where the internal stresses may be particularly high. For example, the annealing may be performed after dividing the board element into board members and before further dividing the board members into at least two panels. Thereby, a dimensional stability of the panels may increase.

In accordance with a second aspect of the disclosure, there is provided a board element, such as a panel, obtainable by the process according to any of the embodiments of the first aspect.

In accordance with a third aspect of the disclosure, there is provided an arrangement for manufacturing a board element comprising at least one cavity, preferably a plurality of cavities, wherein the arrangement comprises an impression device comprising at least one impression element.

The arrangement may further comprise a substrate heating device and/or a cooling unit, preferably arranged downstream of the substrate heating device.

The arrangement may further comprise a substrate forming arrangement.

The substrate forming arrangement may comprise an (co-)extruder and, preferably, a roller assembly.

The substrate heating device may be provided in the substrate forming arrangement.

The substrate heating device may be a separate heating device.

The substrate forming arrangement may comprise a pressing device, such as a continuous press or a static press. The continuous press may be a double-belt press.

The static press may be a multi-daylight press or a short-cycle press.

The impression device may comprise at least one roller.

The impression device may comprise an impression press plate provided with a structured surface comprising the protruding impression element(s).

The arrangement may further comprise a continuous press, such as a double-belt press, or a static press, such as a multi-daylight press or a short-cycle press.

The arrangement may further comprise a pre-shaping device.

The arrangement may further comprise a board dividing device configured to divide the board element into at least one, such as at least two, panels.

The arrangement may further comprise a support member adapted to support at least an inner portion of at least one cavity of the board element.

The arrangement may further comprise an annealing unit.

In accordance with a fourth aspect of the disclosure, there is provided a panel comprising at least one layer comprising a thermoplastic material, wherein the panel comprises at least one cavity in a rear side of the panel, preferably a plurality of cavities. The cavities may be impressed cavities. In some embodiments, however, the cavities may be created by means of removing material from the rear side.

The at least one cavity may taper. A cavity wall may be inclined with respect to a normal direction of the substrate by a wall angle exceeding 0.5°, such as exceeding 1.0° or even exceeding 3.0°. Alternatively, or additionally, the tapering cavity may comprise a chamfer.

The at least one cavity may be provided in an interior of the rear side.

The panel may be rectangular, and the at least one cavity may intersect at least a portion of a locking device provided on a long and/or a short edge portion of the panel. Thereby, a less accurate positioning of the cavities may be required and the manufacturing of the board element may be simplified.

Any layer, some layers, or each layer may comprise a thermoplastic material comprising thermoplastic polymers, such as PVC, and preferably a filler.

A surface of an inner portion of the at least one cavity may be closed (“closed” being defined elsewhere herein).

The at least one cavity may be elongated. A ratio between longitudinal and transverse extensions thereof may be 1<LE/TE≤150, such as 6≤LE/TE≤120, preferably 10≤LE/TE≤100.

The at least one cavity may have an extension along a pair of non-parallel, such as perpendicular, horizontal directions that are substantially the same.

A depth of a plurality of cavities may be smaller at long and/or short edge portions of the panel than in an interior of the rear side. Thereby, the locking device may become stronger and/or a more rigid board element section may be provided.

A first and a second group of cavities may be separated from each other along a panel direction by a separation portion, wherein a distance between the cavities along the panel direction between the first and the second group is larger than a distance between the cavities within each of the first and the second groups.

The panel may further comprise a backing layer, such as a balancing layer, wherein the backing layer is continuous at least at a location of the at least one cavity. By being continuous, the backing layer may be unbroken, e.g., without having any holes through it. Thereby, the effect of the backing layer, for example a balancing the panel, may be improved or even maintained.

Embodiments and examples of the second, third and fourth aspects are largely analogous to embodiments and examples of the first aspect, whereby reference is made thereto.

Additionally, the board element or panel in accordance with any of the first, second, third or fourth aspects, may be a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

Generally, all terms used herein, such as in the claims and in the items in the embodiment section below, are to be interpreted according to their ordinary meaning in the technical field, unless explicitly defined otherwise. All references to “a/an/the [element, device, component, means, step, etc.]” are to be interpreted openly as referring to at least one instance of said element, device, component, means, step, etc., unless explicitly stated otherwise. Reference to one or a plurality of “at least one element”, etc., may shortly be referred to as “the element(s)”.

### BRIEF DESCRIPTION OF THE DRAWINGS

The disclosure will in the following be described in connection to exemplary embodiments and in greater detail with reference to the appended exemplary drawings, wherein:

FIGS. 1a-1c, 2a-2b illustrate in side views embodiments of an arrangement for manufacturing a board element comprising cavities and its use.

FIGS. 2c-2f illustrate in side views embodiments of an impression device.

FIGS. 3a-3e illustrate in side views embodiments of an arrangement comprising an impression device and its use (FIGS. 3a-3c and 3e), and an embodiment of an impression member (FIG. 3d) that may be used, e.g., in the embodiment in FIG. 3c.

FIGS. 4a-4f illustrate embodiments of an impression device in a perspective view (FIG. 4a) and a side view (FIG. 4b), an embodiment of an impression member in a perspective view (FIG. 4c) and a sectional side view (FIGS. 4d), and a schematic embodiment of an impression member in a perspective view (FIG. 4e) and a side view (FIG. 4f).

FIGS. 5a-5b illustrate an embodiment of an impression member in a perspective view (FIG. 5a) and an embodiment of an impression device comprising such an impression member in a side view (FIG. 5b).

FIGS. 5c-5e illustrate in (cross-sectional) side views embodiments of an impression member (FIGS. 5c-5d) and a substrate (FIGS. 5c-5e).

FIG. 5f illustrates an embodiment of an impression member in a perspective view.

FIGS. 6a-6d illustrate in perspective views (FIGS. 6a-6b) and in related side views (FIGS. 6c-6d) embodiments of a protruding impression element or of a protruding support element.

FIGS. 6e-6i illustrate in sectional perspective views (FIGS. 6e-6f) embodiments of a support member, and in cross-sectional side views embodiments of an abutment member and a support member (FIGS. 6g-6h) and of a board element or panel (FIGS. 6g-6i).

FIGS. 7a-7e illustrate in a perspective view (FIG. 7a) an embodiment of a board element or panel, and in a top view (FIG. 7b), a bottom view (FIG. 7c) and cross-sectional side views (FIGS. 7d-7e) another embodiment of a board element or panel.

FIGS. 7f-7i illustrate embodiments of a board element or panel in bottom views (FIGS. 7f and 7h) and cross-sectional side views along the sections C1-C1 (FIGS. 7g) and C2-C2 (FIG. 7i) in FIGS. 7f and 7h, respectively.

FIGS. 8a-8h illustrate embodiments of a board element or panel in bottom views (FIGS. 8a, 8c-8d and 8f), a top view (FIG. 8e), and cross-sectional side views along the sections C3-C3 (FIG. 8b), C4-C4 (FIGS. 8g) and C5-C5 (FIG. 8h) in FIGS. 8a, 8e and 8f, respectively.

FIGS. 9a-9b illustrate flow charts of embodiments of a process for manufacturing a board element.

FIGS. 10a-10c illustrate in (cross-sectional) side views embodiments of a pre-shaping device (FIG. 10a), a pre-shaped substrate (FIG. 10b), e.g., along the section A-A in FIG. 10d, and an impression device (FIG. 10c) and its use.

FIGS. 10d-10f illustrate embodiments of a board element or panel in a bottom view (FIG. 10d) and in cross-sectional side views along the sections B-B (FIG. 10e) and C-C (FIG. 10f) in FIG. 10d.

FIGS. 11a-11b illustrate embodiments of a board element or panel in cross-sectional side views.

FIG. 11c illustrates in top views embodiments of conceivable geometries of cavities and/or impression elements.

FIG. 11d illustrates an embodiment of an impression member in a top view.

FIGS. 11e-11f illustrate an embodiment of an impression member in a front view (FIG. 11e) and a side view (FIG. 11f).

FIGS. 11g illustrates an embodiment of a board element in a bottom view.

FIGS. 12a-12c illustrate an embodiment of an impression member in a perspective view (FIG. 12a), a side view (FIG. 12b) and a front view (FIG. 12c).

FIGS. 12d-12g illustrate in bottom views (FIGS. 12d-12e) and an enlarged cross-sectional side view (FIG. 12f) embodiments of a board element configured to be divided into panels, and in a bottom view (FIG. 12g) an embodiment of a panel obtainable from, e.g., the board element in FIG. 12e or 12f.

FIG. 12h illustrates an embodiment of a board element in a cross-sectional side view.

FIGS. 13a-13d illustrate in perspective views (FIGS. 13a-13b) systems used for testing a degree of impression of various panel samples and in side views (FIGS. 13c-13d) the result of the tests.

### DETAILED DESCRIPTION

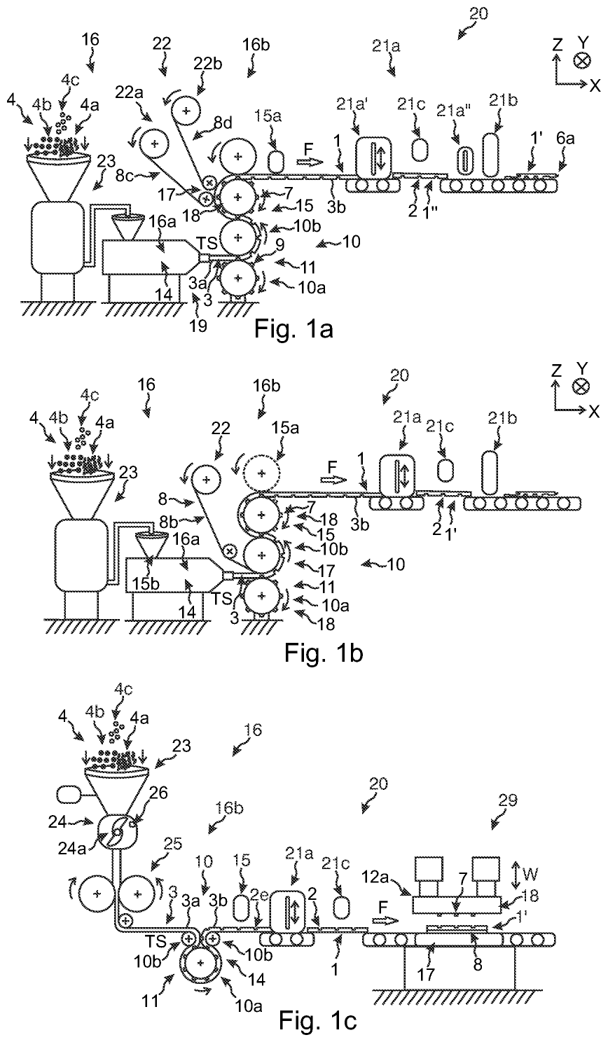

Next, various embodiments of an arrangement 20 for manufacturing a board element 1 comprising at least one cavity 2, preferably a plurality of cavities, in a rear side 5 of the board element, as well as embodiments of a related board element per se, will be described with reference to the embodiments in, e.g., FIGS. 1a-1c, 2a-2f, 3a-3e, 4a-4f, 5a-5f, 6a-6i, 7a-7i, 8a-8h, 9a-9b, 10a-10f, 11a-11g and 12a-12h. The arrangement 20 is capable of implementing a process for manufacturing such a board element 1 from a substrate 3. The board element 1 may be rectangular comprising long 1a, 1b and short 1c, 1d edge portions, but other shapes of the board element, such as square, are equally conceivable.

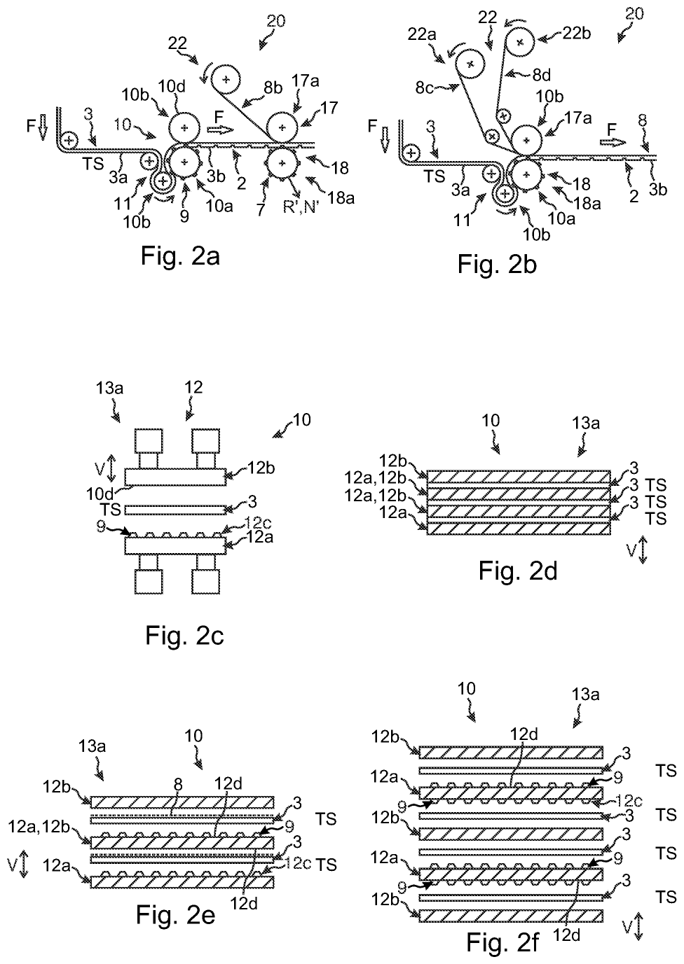

The arrangement 20 extends in a longitudinal X, a transverse Y, and a vertical Z direction. As shown in, e.g., the embodiments in FIGS. 1a-1c, 2a-2f, 3a-3e, 4a-4f, 5a-5d, 5f, 10c, 11d-11f and 12a-12c, the arrangement 20 comprises an impression device 10 comprising at least one protruding impression element 9, preferably a plurality of them. The impression device 10 may comprise an impression member 10a and a mating member 10b. The impression elements 9 are provided on a base portion 10c of the impression member 10a and protrude therefrom in an overall normal direction N of the impression device 10, for example of the base portion 10c. A pressing surface 10d of the mating member 10b may be flat and/or smooth. In some embodiments, however, the pressing surface 10d may be structured for providing an embossing 3d in a front side 3c of the substrate or the board element, such as in a decor structure 8b thereof, cf. FIGS. 2a, 2c, 3c, 7a and 7b .

A substrate 3 in which the cavities are to be created may be provided between, such as fed, between the impression 10a and mating 10b members. During a creation of the cavities 2 in the substrate, the impression member 10a and mating member 10b may be configured to face a rear side 3b and the front side 3c of the substrate, respectively.

In some embodiments, as shown in, e.g., FIGS. 1a-1c, 2a-2b, 4a-4f, 11e-11f and 12a-12c, the impression device 10 comprises at least one roller 11, each preferably being rotatably arranged in the arrangement 20. The impression 10a and mating 10b members may comprise an impression roller 11a and a mating roller 11b, respectively. The overall normal direction N may correspond to a radial direction R of the impression roller 11a, preferably being perpendicular to a circular base portion 10c. The rollers 11a and 11b may be rotatable around an axis AX and an axis BX, respectively, thereby defining a rotational direction thereof.

In some embodiments, as shown in, e.g., FIGS. 2c-2f, 3a-3e, 5a-5d, 5f and 11d, the impression device 10 comprises a press plate assembly 12. The impression 10a and mating 10b members may comprise an impression press plate 12a provided with a structured surface 12c and a mating plate 12b, respectively. The structured surface 12c may comprise protrusions in the form of impression elements 9 and intermediate lower portions 9f, such as depressions, provided therebetween. For example, the structured surface 12c may be part of an embossing plate. The overall normal direction N may be perpendicular to a horizontal plane HP, preferably being provided along the base portion 10c.

The impression 10a and mating 10b members, such as the impression press plate 12a and the mating plate 12b, may be relatively displaceable with respect to each other along a, preferably vertical, direction V.

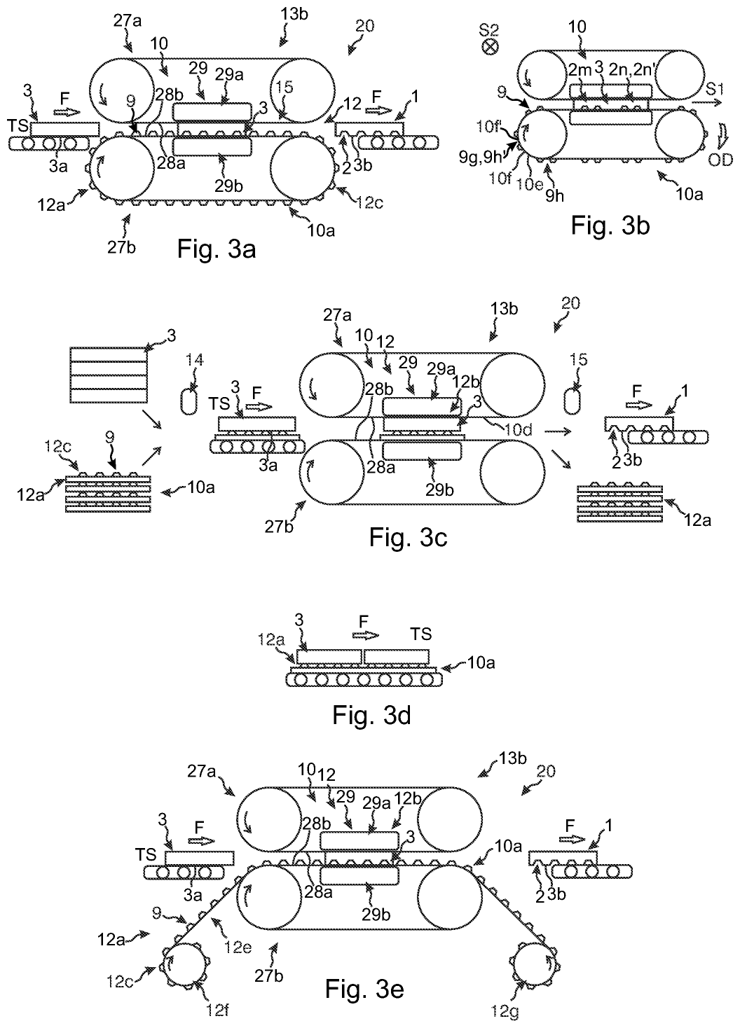

The press plate assembly 12 may be provided in a static press 13a, such as a short-cycle press (see, e.g., FIG. 2c) or a multi-daylight press (see, e.g., FIGS. 2d-2f), or a continuous press 13b, such as a double-belt press (see, e.g., FIGS. 3a-3e).

In some embodiments, the static press 13a may comprise at least two impression press plates 12a, and preferably at least two mating plates 12b, see, e.g., the generic schematic embodiment in FIG. 2d and the more particular embodiments in FIGS. 2e-2f. The press plate 12a may comprise impression elements 9 on a base portion 10c provided on a single side 12d of the press plate, see, e.g., FIG. 2e, or on two opposite sides 12d of the press plate, see, e.g., FIG. 2f. As shown in FIGS. 2e-2f, an opposite side 12d of an interior press plate 12a may form a portion of a mating plate 12b.

In, for example, FIG. 2e, the substrates 3 may be arranged face-to-back (front-to-rear) in the press 13a. Moreover, the substrates 3, e.g., FIG. 2f, may be arranged face-to-face (front-to-front) or back-to-back (rear-to-rear) in the press 13a.

The double belt-press may comprise an upper 27a and a lower 27b endless belt unit. The impression press plate 12a may be provided as a portion of a belt 28b of the lower 27b (or upper 27a) endless belt unit, see, e.g., FIG. 3a. Moreover, the mating plate 12b may be provided as a portion of a belt 28a of the upper 27a (or lower 27b) endless belt unit, see, e.g., FIGS. 3a-3c and 3e.

In some embodiments, and as shown in FIGS. 3c-3e, a part of the impression press plate assembly 12 may be provided separately from the double-belt press. The impression press assembly 12 may comprise a plurality of separate impression press plates 12a, see, e.g., FIGS. 3c-3d. The separate impression press plates may be configured to be reused, preferably several times. The impression press plates 12a in FIG. 3c and FIG. 3d are adapted to create cavities 2 in an individual substrate 3 and at least two substrates 3, respectively.

In some embodiments, and as shown in FIG. 3e, the impression member 10a comprises a flexible member 12e comprising the impression elements 9, preferably being configured to be winded on a reel 12f, 12g upstream and/or downstream of the double-belt press.

The impression member 10a, for example the impression press plate 12a or the flexible member 12e, such as the impression elements 9, e.g., in any of FIGS. 1a-1c, 2a-2f, 3a-3e, 4a-4d, 5a-5f, 6a-6d, 10c, 11d-11f and 12a-12c, may comprise a structured paper, a structured sheet, such as a metal sheet or a phenolic sheet, or a structured foil, such as a polymer-based foil. The metal may comprise steel.

The substrate 3 may be transported from an inlet of the double-belt press to a pressing member 29 thereof. The pressing member 29 may comprise an upper 29a and/or a lower 29b press member configured to apply pressure, and preferably heat, to the substrate 3 for creating the cavities 2.

Generally herein, a feeding speed of an arrangement 20 comprising an extruder may be 0.5-10 m/min, preferably 1-8 m/min, more preferably 1.5-6.0 m/min. Moreover, a feeding speed of an arrangement 20 comprising a continuous press, such as a double-belt press, may be 2-20 m/min, preferably 3-15 m/min, more preferably 4-13 m/min. The arrangement 20 in, e.g., FIGS. 1a-1b, may be included in an SPC production line.

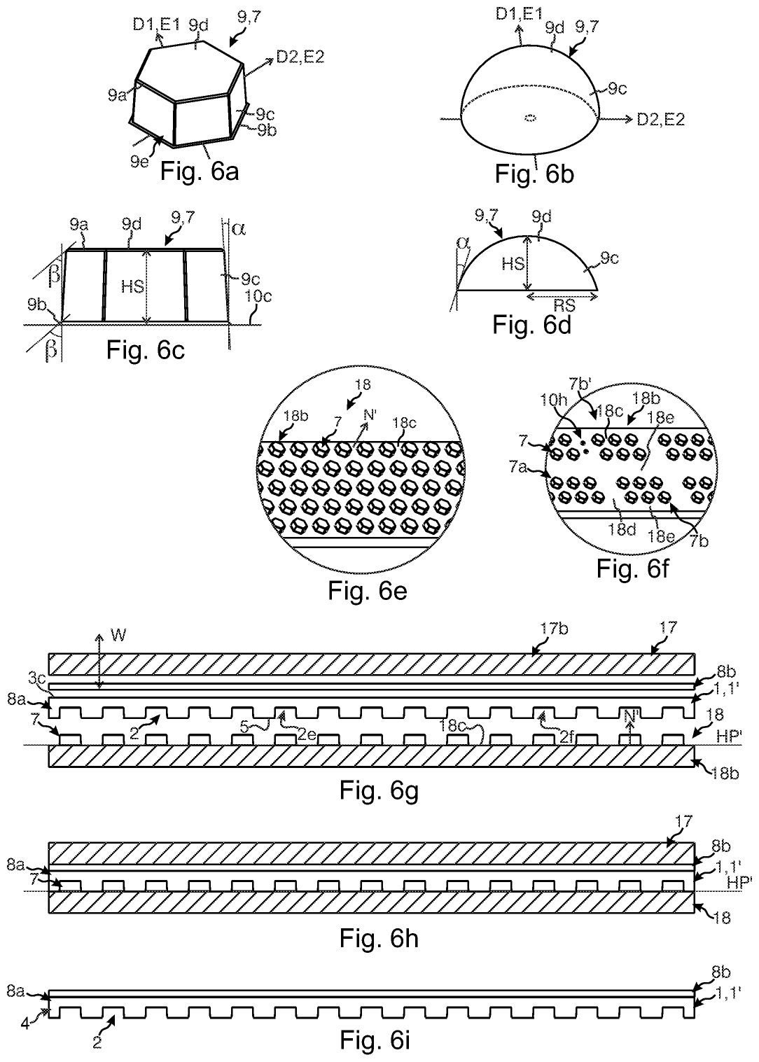

The protruding impression elements 9 (or the support elements 7 defined below) in any embodiment herein, such as in FIGS. 1a-1c, 2a-2f, 3a-3e, 4a-4f, 5a-5d, 5f, 6a-6h, 10c, 11d-11f and 12a-12c, may be of frustro-conical form or semi-spherical form, or may be formed as a, preferably rectangular, parallelepiped, a polyhedron, a prismatoid, such as a prism, etc. FIGS. 6a-6d illustrate semi-spherical impression elements and prismatoid impression elements. For example, the form may be determined from the base portion 10c.

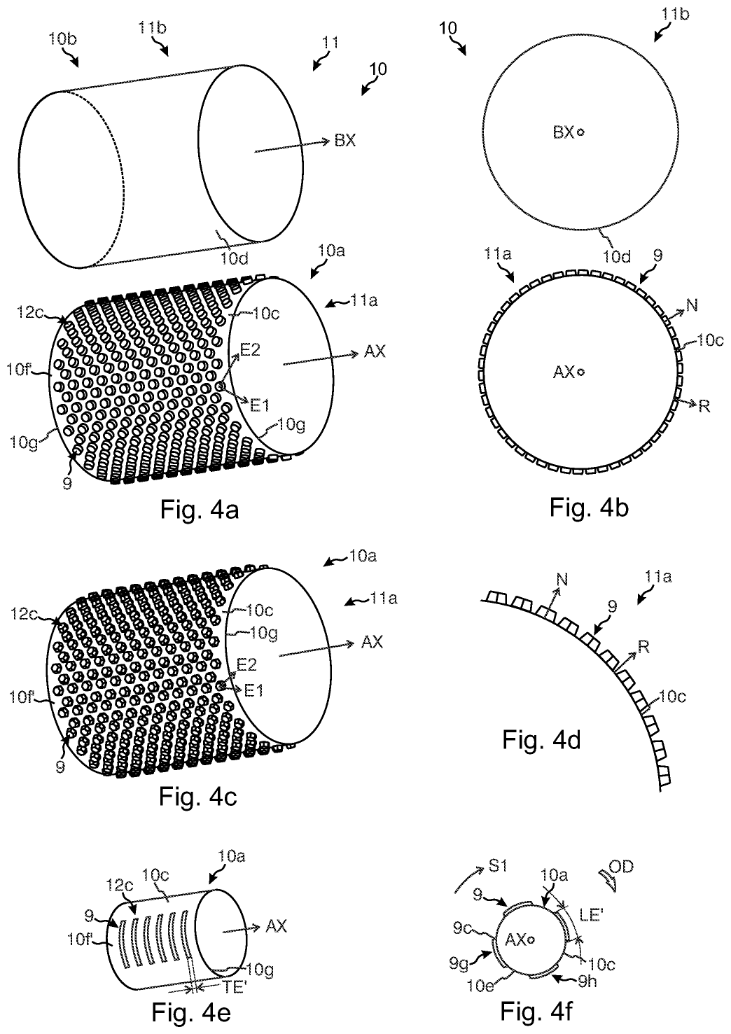

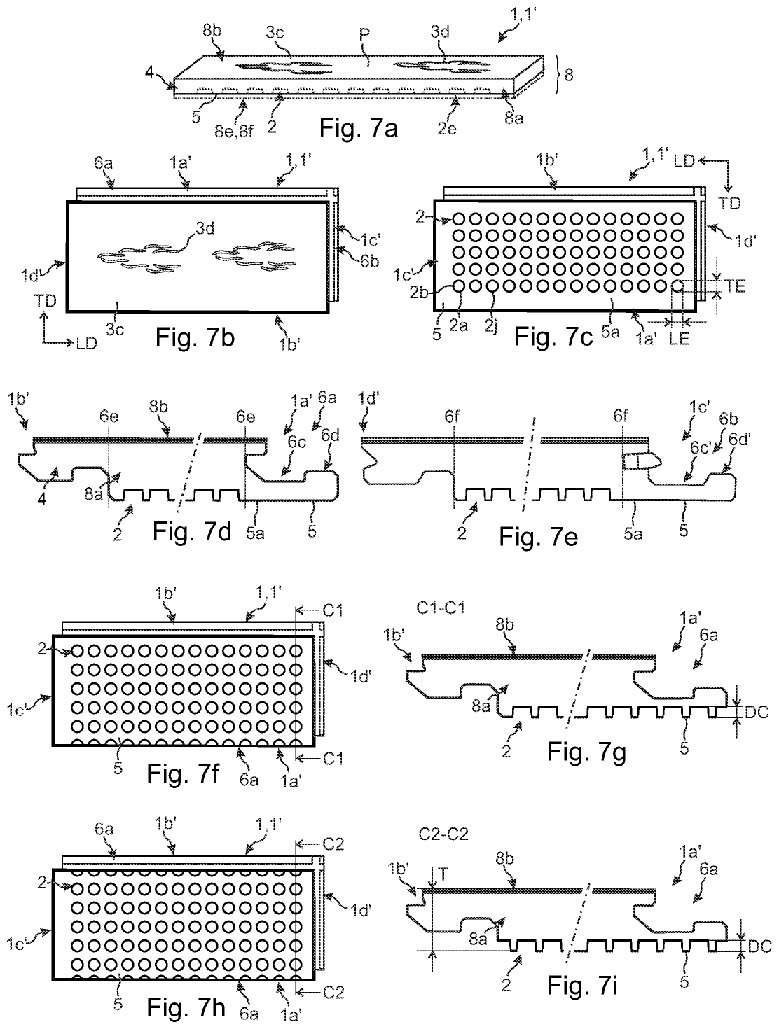

As shown in, e.g., FIGS. 4a-4d, 5a-5b, 5f, 6a-6d, 11d-11f and 12a-12c, extensions of the impression elements 9 along a pair of non-parallel, such as perpendicular, horizontal directions E1, E2 may be substantially the same. Generally herein, the horizontal extensions E1, E2 may be determined at the base of the impression element. Thereby, circumscribed cavities 2 may be created having extensions along a pair of non-parallel, such as perpendicular, horizontal directions D1, D2 that are substantially the same. For example, the cavities 2 may have a boundary shaped as a circle or a, preferably regular convex, polygon, such as a triangle, square, pentagon, hexagon, etc., see FIGS. 7c-7i, 10a-10b, 11a-11c, 11g and 12d-12g. The horizontal extensions E1, E2 may have components along the X and Y directions during impression.

The at least one impression element 9 may be tapering, preferably in a direction away from the base portion 10c, such as in the overall normal direction N. In any of the embodiments in FIGS. 1a-1c, 2a-2f, 3a-3e, 4a-4f, 5a-5d, 5f, 6a-6d, 10c, 11d-11f and 12a-12c, a draft angle a between a lateral wall portion 9c of the impression element 9 and an overall normal direction N of the impression device 10 may exceed such as exceeding 1.0° or even exceeding 3.0°. For example, a may be 0.5-70°, such as 0.5-45° or 1-30 °. In some embodiments, as shown in, e.g., FIGS. 4a-4f, 5a-5d, 6a, 6c, 10c, 11d-11f and 12a-12c, the lateral wall portion 9c may be substantially planar. Alternatively, as shown in FIGS. 6b and 6d, the lateral wall portion 9c may be curved. For example, a radius RS of the impression element may be larger than a height HS thereof, such that α>0°, cf. the semi-spherical impression element in FIG. 6d.

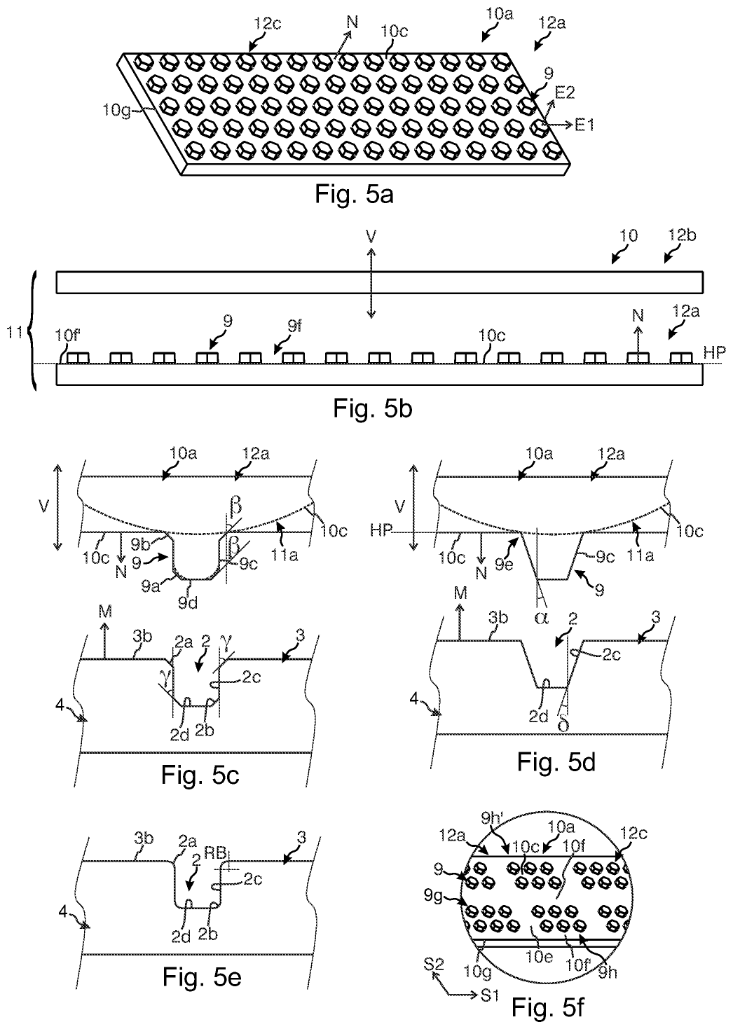

Other types of tapering impression elements are equally conceivable. In some embodiments, the at least one impression element 9 may comprise a bevel, such as an outer 9a and/or an inner 9b bevel, see, e.g., FIG. 5c. The outer bevel 9a may be provided between the lateral wall portion 9c and an outer wall 9d. The inner bevel 9b may be provided in an inner region 9e of the impression element 9 adjacent to the base portion 10c. The bevel 9a and/or 9b may be inclined with respect to the overall normal direction N by an angle β. For example, the bevel angle(s) β may be such as 25-40°, for example 45°.

The arrangement 20 may comprise a substrate forming arrangement 16, preferably provided upstream from the impression device 10, see, e.g., FIGS. 1a-1c. A hardened or cured substrate 3 may provide a core 8a of the board element 1. Optionally, the substrate 3 may comprise additional layers 8, for example obtained from a co-extruded substrate.

As shown in the embodiment in, e.g., FIGS. 1a and 1b, the substrate forming arrangement 16 may comprise an extruder 16a (or a co-extruder) and a roller assembly 16b for calendaring an extrudate from the extruder. The extruder 16a may communicate with a material container 23 configured to receive a thermoplastic material 4 comprising thermoplastic polymers 4a and preferably a filler 4b, for example via a hopper.

In some embodiments, and may be seen in, e.g., FIG. 1c, the substrate forming arrangement 16 may comprise a roller mill 25, preferably a two-roller mill, communicating with a material container 23, and a roller assembly 16b. The substrate forming arrangement 16 may further comprise a mixer 24, such as a Banbury mixer or a kneader, located upstream from the roller mill 25, and preferably a heater 26 for heating a thermoplastic material 4, preferably comprising thermoplastic polymers 4a and a filler 4b, received in the material container 23. The mixer 24 may comprise a rotatable mixing member 24a, e.g., comprising at least one rotor. Optionally, the mixer 24 and heater 26 may be combined. In some embodiments, heat may be provided by friction.

The roller assembly 16b in any of FIGS. 1a-1c may include at least three rolls, such as 4, 5 or 6 rolls, for example arranged vertically above each other. In FIG. 1b, the fourth roller displayed in a broken line is optional. By means of the roller assembly 16b, the extrudate or the heated material from the roller mill 25, preferably in the form of a paste, may be calendared into a substrate 3 in the form of a, preferably continuous, sheet. The sheet may have an essentially constant thickness.

The arrangement 20 may comprise a substrate heating device 14. In some embodiments, and as shown in, e.g., FIGS. 1a-1b, the substrate heating device 14 may be provided in the substrate forming arrangement 16. For example, an extrudate from the (co-)extruder may be provided at an elevated temperature TS, such as 90-225° C., such as 145-220° C. In some embodiments, and as shown in, e.g., FIGS. 1c and 3b, the substrate heating device 14 may be a separate heating device, for example in the form of one or several tempered rollers or in the form of an infrared heater. For example, in any of FIGS. 1a-1c, the first and second rollers 11, and optionally the third roller 11, along a feeding direction F may be heated. It is clear that the substrate 3 disclosed herein, such as in any of FIGS. 1a-1c, 2a-2f, 3a-3e, and 10c, may be provided at the elevated temperature TS by means of any of these alternatives.

Alternatively or additionally to the substrate heating device 14, the arrangement 20 may comprise a cooling unit 15 and/or 15a preferably arranged downstream of and/or at the substrate heating device 14. The cooling unit 15 (15a) may be adapted to face the rear side 3b (front side 3c) and may be configured to cool the rear side 3b (front side 3c). The cooling unit 15 and/or 15a may be separately arranged and may be provided in the form of one or several tempered rollers, see for example FIGS. 1a-1c, in the form air cooling or direct or indirect fluid cooling, see for example FIG. 1a and 1c, or in the form of a cooling zone of the double-belt press, see for example FIGS. 3a-3c.

In some embodiments, the cavities 2 may be created in the substrate 3 by means of an isochoric pressing operation. This may be particularly advantageous when the substrate 3 is formed in a substrate forming arrangement 16, such as when it is provided in the form of a low-viscosity paste when creating the cavities. Thereby, a control of the thickness of the substrate may become improved. In a first example and, e.g., in any of FIGS. 1a-1c or 2a-2b, the impression 10a and mating 10b members in the form of rollers 11a, 11b may be arranged at a fixed distance from each other, such as in the vertical direction Z. In a second example and, e.g., in FIGS. 2c-2f and 3a-3e, the cavities 2 may be created in an isochoric pressing operation by application of the press plate assembly 12.

In some embodiments, the cavities 2 may be created in the substrate 3 by means of an isobaric pressing operation, for example in a static 13a or a continuous 13b press. This may be particularly advantageous when the substrate 3 is preformed and when a substrate portion 3a thereof is separately heated, see, e.g., FIGS. 2c-2f and 3a-3e.

Optionally, the substrate forming arrangement 16 may comprise a top layer roller arrangement 22 comprising a decorative layer 22a and/or a wear layer 22b roller arrangement. Such a top layer roller arrangement 22 is shown in more detail in FIGS. 1a and 2b and more schematically in FIGS. 1b and 2a, but is conceivable in any embodiment herein, such as in or in relation to any of FIGS. 1c, 2a-2f, 3a-3e, 4a-4f, 6g-6h and 10a-10c. Thereby, a decor structure 8b, such as a decorative layer 8c and/or a wear layer 8d, may be continuously laminated to the board element 1 after or during its forming. The decor structure 8b may be applied to the board element 1 under pressure from the rollers in the top layer roller arrangement 22, preferably without using an adhesive. Optionally, the board element 1 may be heated during the lamination, such as by IR heat or by means of one or several heated rollers in the top layer roller arrangement 22 and/or in the roller assembly 16b. In some embodiments, the decor structure 8b may be formed by, preferably digitally, printing a print P directly on the board element 1 or core 8a and optionally providing a wear layer 8d thereon, cf., e.g., FIG. 7a. In some embodiments, a backing layer 8e may be laminated to the board element 1 after creating the cavities 2.

At least one layer 8 may be in some embodiments be laminated to the board element 1 in a pressing member 29, such as a static press, preferably under heat, see, e.g., FIG. 1c. The layer 8 may be a decor structure 8b and/or a backing layer 8e. Alternatively, the layer 8 may provide dimensional stability to the panel. For example, the layer 8 may be a mineral-based layer, preferably comprising magnesium oxide and optionally magnesium chloride (e.g., MgCl₂) and/or magnesium sulphate (e.g., MgSO₄).

In some embodiments, as shown in FIGS. 1a-1c, 2a-2b and 6e-6h, the arrangement 20 may further comprise a support member 18 adapted to support at least an inner portion 2f of the cavities 2 of the board element 1 and/or adapted to calibrate the cavities after their creation. The created cavities 2 may be supported during lamination of a layer 8 to the board element 1 and/or during cooling of at least a cavity region 2e of the board element 1. Alternatively, or additionally, the inner portion 2f may be supported during pressing of the substrate 3 between rollers. In FIG. 1b, the cavities 2 may in effect be supported during the lamination of a layer 8 and during the creation of the cavities 2.

The support member 18 may comprise at least one protruding support element 7, preferably a plurality of them. The support elements 7 are provided on a base member 18c of the support member and protrude therefrom in an overall normal direction N′ of the support member 18, for example of the base member 18c. The support member 18 may be a support roller 18a (see FIGS. 1a-1b and 2a-2b) or a support plate 18b (see FIGS. 1c and 6e-6h). The overall normal direction N′ may correspond to a radial direction R′ of the support roller 18a, preferably being perpendicular to a circular base member 18c. Alternatively, the N′ may be perpendicular to a horizontal plane HP′, preferably being provided along the base member 18c. The board element 1 may be pressed between the support member 18 and an abutment member 17, which may be an abutment roller 17a or an abutment plate 17b. Some embodiments of the support 18 and the abutment 17 members may be the same as those of the impression 10a and mating 10b members, respectively, such as in FIGS. 1a-1c, 2a-2f, 3a-3e, 4a-4f, 5a-5d, 6a-6d, 10c, 11e-11f and 12a-12c, whereby reference is made thereto for details.

In FIG. 1b, the third roller 11 along the feeding direction F may optionally also operate as a support member 18, as indicated by support elements 7 in broken lines.

The support member 18 and abutment member 17, such as the support plate 18b and the abutment plate 17b, may be relatively displaceable with respect to each other along a, preferably vertical, direction W.

As indicated elsewhere herein, a form of the support elements 7 may be the same as the form of the impression elements 9. Moreover, the support member 18, for example the support plate 18a and/or the support elements 7, e.g., in any of FIGS. 1a-1d, 2a-2b and 6a-6h, may comprise a structured paper, a structured sheet, such as a metal sheet or a phenolic sheet, or a structured foil, such as a polymer-based foil. The metal may comprise steel.

In some embodiments, e.g., as shown in FIGS. 1b, 2b and 2e, at least one layer 8 may be attached, such as laminated, to the substrate 3 while creating, and preferably supporting, the cavities 2. The impression member 10a may thereby further operate as a support member 18. The layer 8 may be a decor structure 8b and/or a backing layer 8e. For example, a decorative 8c and/or wear 8d layer(s) may be laminated to the substrate 3. An optional layer 8 being attached to the substrate 3 while creating cavities 2 therein is indicated by broken lines in FIG. 2e. Such a layer 8 is conceivable in any of FIGS. 2c-2f, 3a-3e and 10c. In some embodiments, the layer 8 may be a mineral-based layer, cf. the discussion above.

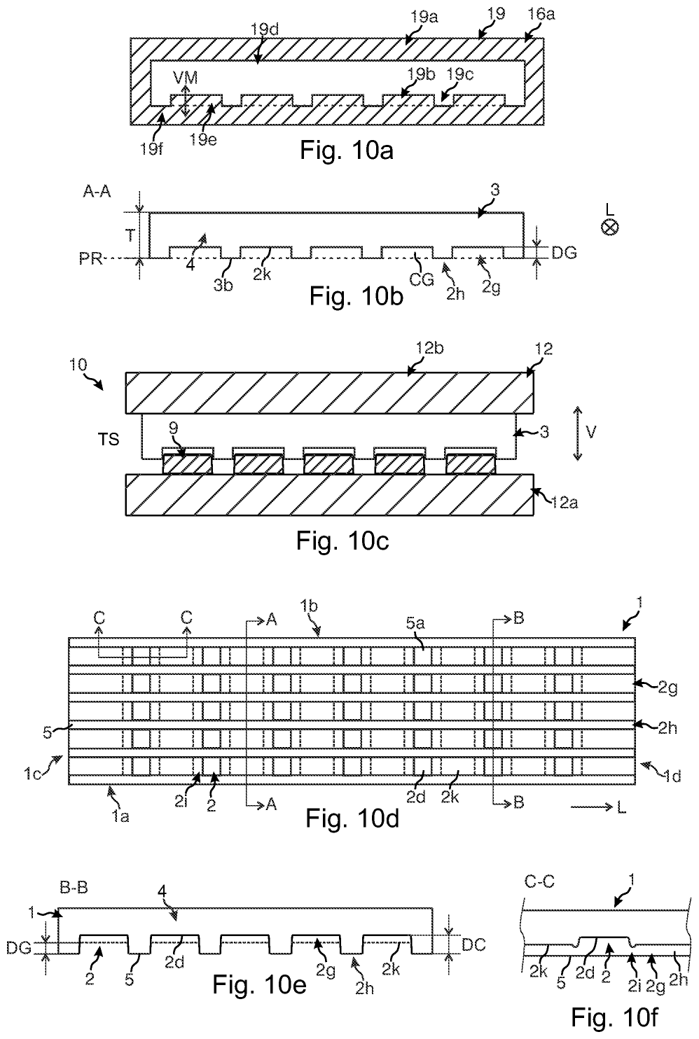

In some embodiments, the arrangement 20 may comprise a pre-shaping device 19, see, e.g., FIGS. 1a and 10a. The pre-shaping device 19 may be a (co-)extruder 16a comprising a die 19a, preferably having a varying shape comprising projections 19band recesses 19c. The substrate 3 may be (co-)extruded through an opening 19d of the die. For example, the pre-shaping device 19 in the form of a (co-)extruder 16a may be included in the arrangement 20 in either of FIGS. 1a-1b. In some embodiments, the pre-shaping device 19 may be part of a pressing device.

As shown most clearly in FIG. 10b, the pre-shaping device 19 may be configured to form a substrate 3 comprising at least one groove 2g, preferably a plurality of grooves 2g, in a rear side 3b of the substrate. The grooves may be separated by protuberances 2h. A portion of the rear side 3b may form a lower section of the protuberance 2h. Each groove 2g and each protuberance 2h may correspond to a projection 19b and a recess 19c of the extruder 16a, respectively.

Preferably, a cross-section CG of the grooves 2 is substantially constant along a longitudinal extension L of the grooves 2g. The cross-section CG may be an area delimited by a plane PR extending along the rear side 3b. An opening 19d of the die may thereby be stationary. For example, the projections 19b may be fixedly mounted in the die 19a. However, in some embodiments, the cross-section CG may vary along the longitudinal extension L. For example, the varying cross-section may be obtained by means of a die 19a comprising an adjustable opening 19d. The opening 19d may comprise one or several movable parts 19e, preferably in the form of movable projections 19b (see broken line in FIG. 10a). The movable parts 19e may be movable in a direction VM w.r.t. a die body 19f.

After pre-shaping the substrate 3, cavities 2 may be created in the rear side 3b by an impression device 10, for example comprising roller(s) 11 as shown in FIGS. 1a-1b or comprising a press plate assembly 12 as shown, e.g., in FIG. 10c. As illustrated in FIGS. 10c-10f, the impression elements 9 may, preferably selectively, impress an inner section 2k of the grooves 2g, such as along the longitudinal extension L. Other features and examples of the impression, such as providing the substrate at an elevated temperature TS, may be similar to the impression acts described elsewhere herein, whereby reference is made thereto. A part of the space provided by the grooves 2g may serve as an expansion area 2i for material that is shaped, preferably displaced, during the impression, see FIGS. 10d and 10f.

Hence, as shown in FIGS. 10d-10e, together with FIG. 10b, the board element 1 may comprise grooves 2g and cavities 2 having different depths DG, DC, preferably such that DC>DG. A depth DG of the grooves 2g, preferably from the rear side 3b to the inner section 2k of the grooves, may be less than one third of a, preferably maximal, thickness T of the substrate 3. For example, 0.05*T≤DG≤0.30*T. When the cross-section CG varies as described above, the depth DG may be smaller at the long 1a, 1b and/or short 1c, 1d edge portions of the board element 1 than in the interior 5a of the rear side 5. In preferred examples, the depth DG may be essentially zero at the long and/or short edge portions, such that the cross-section CG is essentially rectangular, and non-zero in the interior 5a. Generally herein (with or without grooves 2g), a depth DC of the cavities 2, preferably from the rear side 3b to a bottom wall 2d of the cavities 2, may be at least one third of a, preferably maximal, thickness T of the substrate 3. For example, 0.15*T≤DC≤0.70*T, preferably 0.35*T≤DC≤0.65*T.

As shown in, e.g., FIGS. 1a-1c, but is conceivable in any embodiment herein, the arrangement 20 may further comprise a board dividing device 21a and/or a profiling unit 21b. The board dividing device 21a may be configured to divide the board element 1 into at least one panel 1′, such as at least two panels 1′. The profiling unit 21b may be adapted to produce a locking device 6a, 6b on at least one edge portion 1a′, 1b′, 1c′, 1d′ of the board element 1 in the form of a panel 1′ or at least one panel 1′ into which the board element has been divided. For example, a locking device 6a and/or 6b may be produced on long 1a′, 1b′ and/or short 1c′, 1d′ edge portions, preferably by machining.

As illustrated in, e.g., FIGS. 1c, 3a-3e, 6i, 7a, in some embodiments, the manufactured board element 1 or panel 1′ does not comprise a locking device. For example, they may be assembled in a loose-lay configuration, preferably in mutual abutment.

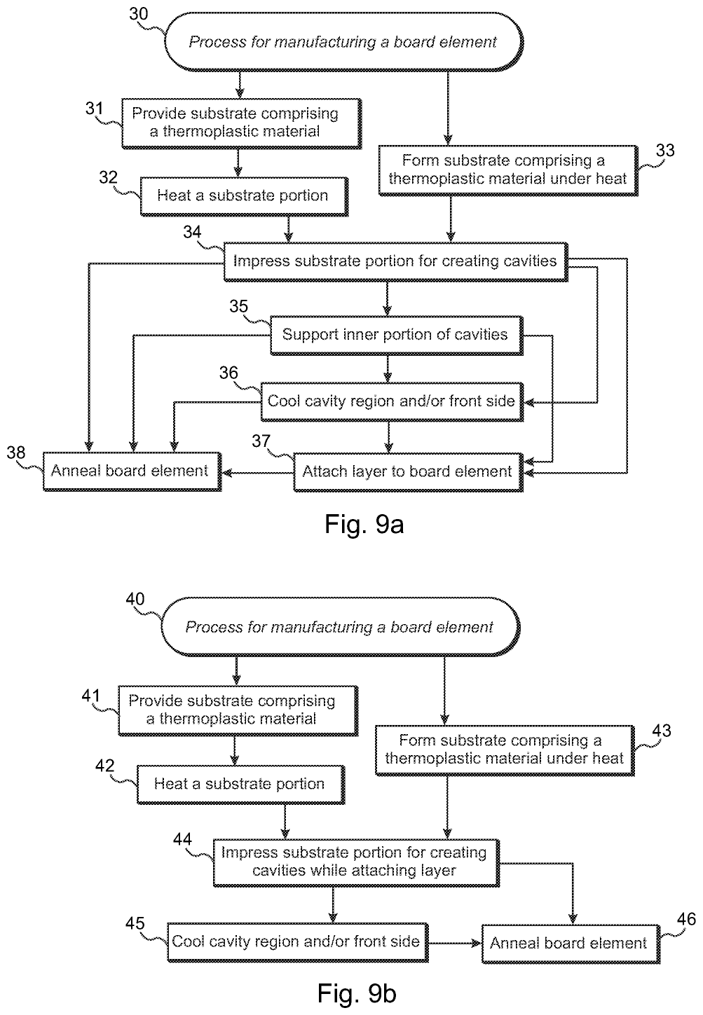

The arrangement 20 in, e.g., any of FIGS. 1a-1c, 2a-2f, 3a-3e, 4a-4f, 5a-5d, 5f, 6e-6h, 10c, 11d-11f and 12a-12c, is capable of implementing a process for manufacturing a board element 1 comprising at least one cavity, preferably a plurality of cavities 2. The flow charts in FIGS. 9a and 9b illustrate embodiments of such a process (Box 30 or 40).

First, a substrate 3 comprising a thermoplastic material 4 is provided (Box 31 or 41). The substrate 3 may be preformed and a substrate portion 3a thereof may be heated by a substrate heating device 14 (Box 32 or 42), such that the substrate portion 3a or even the entire substrate 3 becomes disposed at an elevated temperature TS. In some embodiments, the elevated temperature TS may be obtained during a forming of the substrate 3 under heat and, preferably, pressure (Box 33 or 43). For example, the substrate 3 may be at least partially formed in a (co-) extruder 16a or in a pressing device. In some embodiments, the substrate 3 may be pre-shaped in a pre-shaping device 19, which may be provided by the (co-)extruder 16a. The pre-shaped substrate 3 may comprise grooves 2g. In any of the embodiments above, the elevated temperature TS may exceed 40° C., preferably being 40-295° C., more preferably 100-295° C.

The substrate portion 3a, preferably the entire substrate 3, may comprise a thermoplastic material 4 comprising thermoplastic polymers 4a, such as PVC, PE, PP, TPU, PET, EVA, PA, PS, PVAc, PMMA, PVB, PC, ABS, PAM, PBT, or CPVC, and a filler 4b. The filler 4b may comprise, or may be, an inorganic filler, such as a mineral material, for example calcium carbonate (CaCO₃), limestone, such as chalk, talc, fly ash, or a stone material, such as stone powder. When the thermoplastic material 4 comprises PVC, the elevated temperature TS may be 50-210° C., preferably 60-180° C., more preferably 110-180° C. When the thermoplastic material 4 comprises PP, the elevated temperature TS may be 60-220° C., preferably 70-175° C., more preferably 100-175° C. When the thermoplastic material 4 comprises PET, the elevated temperature TS may be 70-295° C., preferably 110-280° C., more preferably 130-280° C.

Thereafter, the cavities 2 are created in a rear side 3b of the substrate 3 by impressing the heated substrate portion 3a by impression elements 9 (Box 34 or 44). This may be implemented by any of the impression devices 10 disclosed herein, such as in any of FIGS. 1a-1c, 2a-2f, 3a-3e, 4a-4f, 5a-5d, 6a-6d, 10c, 11d-11f and 12a-12c. The substrate 3 may in some embodiments, such as in FIGS. 1a-1c, 2a-2b and 3a-3e, be displaced in the feeding direction F during the creating of the cavities. The substrate may be fed along the longitudinal X and/or vertical Z direction(s). For example, the impression device 10 comprises an impression roller 11a and a mating roller 11b, or it comprises an impression press plate 12a and a mating plate 12b. Thereby, a board element 1 comprising cavities 2 in its rear side 5 may be obtained.

An impression press cycle of the static press 13a, preferably the short-cycle press, may exceed 5 seconds, such as exceeding 10 seconds, preferably when the substrate 3 is provided at the elevated temperature TS. In a non-limiting example, the press cycle may be 20-50 seconds. In some embodiments, an impression press cycle in the static press 13a, preferably the multi-daylight press, including heating may be 10-40 minutes, such as 15-35 minutes, such as 20-30 minutes, potentially followed by a cooling cycle of 5-40 minutes, such as 10-30 minutes, such as 15-25 minutes. An impression press cycle of the continuous press, such as the double-belt press, may be 20-400 seconds, such as 25-220 seconds, such as 30-180 seconds.

When a pre-shaped substrate 3 with grooves 2g is provided, the heated substrate portion 3a may include the inner section 2k of the grooves 2g, and the cavities 2 may be created by impressing the inner section 2k by impression elements 9 (Box 34).

The act of impressing may comprise applying a pressure of 0.4-5.0 MPa to the substrate portion 3a, such as 0.5-4.0 MPa or 0.6-3.0 MPa. For example, the applied pressure may be 0.7-2.5 MPa, such as 1.0-2.0 MPa. Any of the pressures above may be conceivable for the static press or the continuous press disclosed herein.

In some embodiments, the process may comprise forming at least one chamfer 2a, 2b in the cavity or cavities 2. The chamfers, such as an outer 2a and/or an inner 2b chamfer, may be formed by the bevels, such as the inner 9b and/or outer 9a bevels, of the impression elements 9. The chamfers 2a, 2b may be provided along a longitudinal LE and/or a transverse extension TE of the cavities 2, such as along the entire circumference of the cavities. Each chamfer 2a, 2b may be disposed between a cavity wall 2c and the rear side 3b, 5 or between the cavity wall 2c and a bottom wall 2d of the cavity 2. The chamfer 2a, 2b may be inclined with respect to a normal direction M of the substrate 3 or board element 1 by a chamfer angle y, see, e.g., FIGS. 5c and 5e. The chamfer angle y may be 10 70°, such as 25-40°, for example 45°. The bevel 9a, 9b and/or chamfer 2a, 2b may be substantially planar (see FIG. 5c) or rounded (see FIG. 5e and the broken line at 9a in FIG. 5c), such as comprising a radius. An extension of a substantially planar bevel and/or substantially planar chamfer may be 0.07-2 mm, such as 0.1-1 mm. For the rounded bevel or rounded chamfer, the radius RB may be 0.05-2.5 mm, such as 0.1-1.2 mm.

More generally, the process may comprise creating a tapering cavity or cavities 2 by means of tapering impression elements 9, see, e.g., FIG. 5d. The cavities 2 may taper along the longitudinal LE and/or transverse TE extension(s). A cavity wall 2c may be inclined with respect to the normal direction M by a wall angle δ, see, e.g., FIG. 5d.

The wall angle δ may exceed 0.5°, such as exceeding 1.0° or even exceeding 3.0°. Alternatively, or additionally, the wall angle δ may be less than 80°, such as being less than 70°, or even less than 50°. For example, the wall angle δ may be 0.5-70°, such as 0.5-45° or 1-30°. Alternatively, or additionally, to the tapering cavity wall 2c, the tapering cavities 2 may comprise a chamfer 2a, 2b described above.

Generally herein, a form of the cavities 2 may correspond to a form of the impression elements 9. For example, the draft angle α and wall angle δ may correspond to each other and/or the bevel angle β and the chamfer angle γ may correspond to each other.

In some embodiments, and as illustrated in, e.g., FIGS. 3b, 5f, 11d-11f and 12a-12c, the impression member 10a may comprise a first 9g and a second 9h (or 9h′) set of impression elements 9 that are separated from each other along a separation direction S1 (or S2) by a blank portion 10e (or 10f). A distance L2 (or L2′) between the impression elements along the separation direction S1 (or S2) between the first and the second sets is larger than a distance L1 (or L1′) between the impression elements within each of the first 9g and the second 9h (or 9h′) sets. As shown in, e.g., FIGS. 3b, 5f, 11d and 12a-12c, the impression member 10a may sometimes comprise a plurality of such second 9h, 9h′ sets along the separation direction(s) S1 and/or S2. Generally herein, a ratio L2/L1 may be at least 3, preferably at least 5, such as at least 10. For example, 3≤L2/L1≤10. Moreover, a ratio L2′/L1′ may be at least 2, preferably at least 5, such as at least 10. For example, 2≤L2′/L1′≤10. In non-limiting examples, L1 (or L1′) may be 1-10 mm, preferably 1-5 mm, more preferably 1.5-4 mm and L2 (or L2′) may be 5-100 mm, preferably 10-75 mm, more preferably 12-50 mm. The separation directions S1 and S2 may be parallel with and perpendicular to an operational direction OD, such as rotational direction, of the impression member 10a, respectively. It is clear to a skilled artisan that the other features of the impression device 10 may be similar to those described elsewhere herein, e.g., in relation to FIGS. 4a-4d, 5a-5f and 6a-6d.

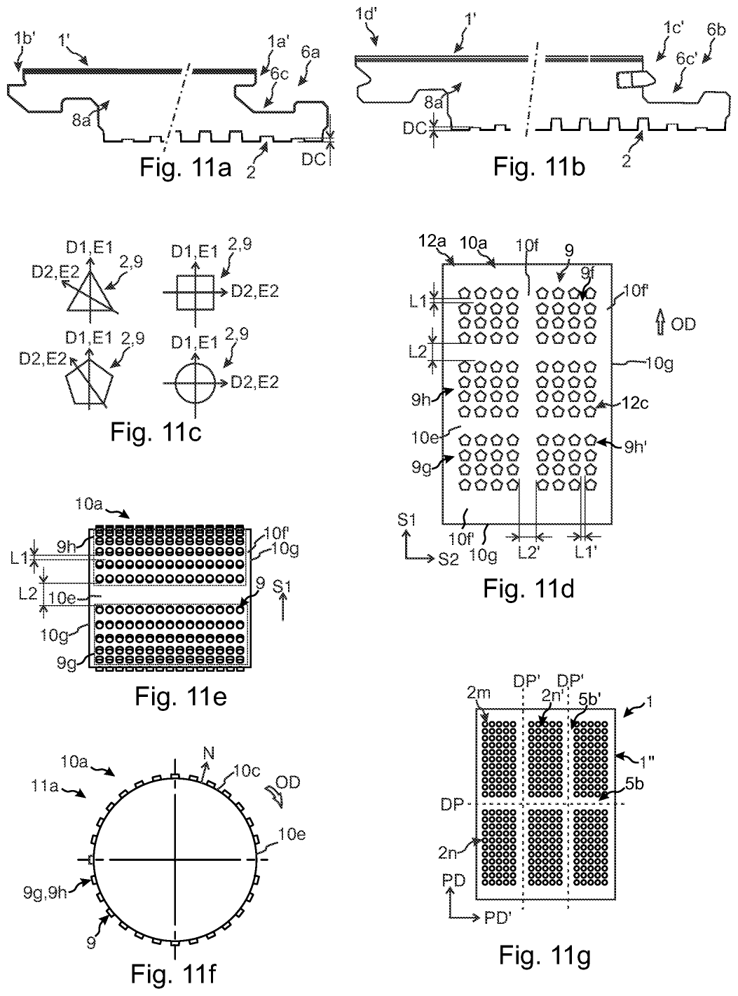

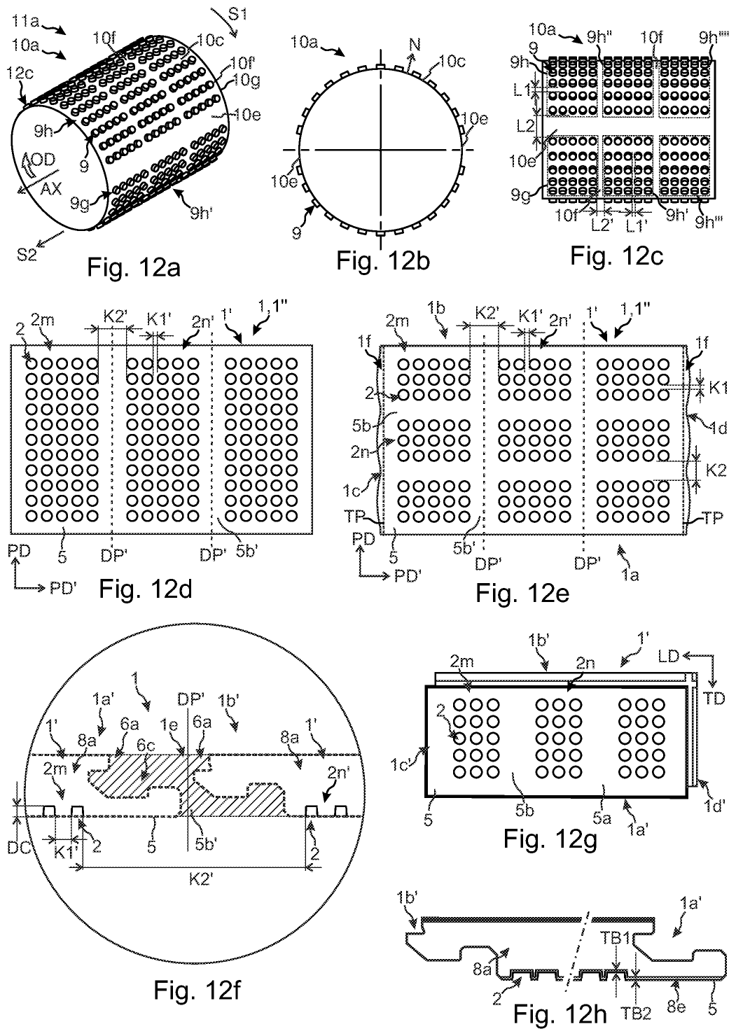

In a first example, the impression member 10a comprises a first 9g and a second 9h set of impression elements 9 separated by a blank portion 10e. In a second example, the impression member 10a comprises a first 9g and a second 9h′ set of impression elements 9 separated by a blank portion 10f. In a third example, the impression member 10a comprises a first 9g and a second 9h set of impression elements 9 separated by a blank portion 10e and a first 9g and a second 9h′ set of impression elements 9 separated by a blank portion 10f. It is emphasized that in any of the examples above, there may be additional second sets 9h″, 9h″′, 9h″″ defined in a similar manner w.r.t. to an adjacent “first” set 9h, 9h′, 9h″, e.g., as shown in FIGS. 12a-12c. It is noted that when there is only one blank portion 10e on a periodic impression member 10a, such as an endless belt unit 27b or an impression roller 11a, e.g., as in FIGS. 11d-11f, the first 9g and second 9h set may be the same.

In FIGS. 4e-4f, two or more sets 9g, 9h of elongated impression elements 9 (further described below) are separated by a blank portion 10e along the operational direction OD of the impression member 10a.

Preferably, the impression elements 9 described herein are spaced from an edge section 10g of the impression member 10a by a space 10f′, such as in a direction perpendicular to the operational direction OD. Thereby, the cavities 2 may be provided in an interior 5a of the rear side 5 as described elsewhere herein. During operation of the impression device 10, the edge section 10g may extend transversely to, and optionally along, the feeding direction F, e.g., along the separation direction(s) S1 and/or S2.

Likewise, as illustrated in, e.g., FIG. 6f, any support member 18 herein may comprise a first 7a and a second 7b (or 7b′) family of support elements 7 that are separated from each other along by a vacant portion 18d (or 18e).

Optionally, the cavity region 2e of the board element 1 or the substrate 3, preferably the rear side 3b, 5, may be cooled by the cooling unit 15 adapted to face the rear side 3b (Box 36 or 45) during and/or after creating the cavities 2. The cavity region 2e may be cooled from the elevated temperature TS to a cooling temperature T_{c} below the elevated temperature.

In some embodiments, the cavity region 2e may be cooled to a cooling temperature T_{c}, such that 0.8≤T_{c}/T_{g}≤1.9. When the thermoplastic material 4 comprises PVC, the range may be 0.8≤T_{c}/T_{g}≤1.9. When the thermoplastic material 4 comprises PET, the range may be 1.0≤T_{c}/T_{g}≤1.4. When the thermoplastic material 4 comprises PP, the range may be 1.0≤T_{c}/T_{g}≤1.9.

In non-limiting examples, the cavity region 2e may be cooled from (i.e., below) the elevated temperature by at least 20° C., preferably 20-120° C. for semi-crystalline polymers, such as PET, and by at least 30° C., preferably 30-90° C., for amorphous polymers, such as PVC.

In some embodiments, the cavity region 2e may be cooled from the elevated temperature TS by at least 10° C., preferably 10-100° C., below Tₘ of the thermoplastic material 4, e.g., comprising PP, PE, TPU or EVA.

In some embodiments, the inner portion 2f of the created cavities 2 may be supported during the cooling (Boxes 35, 36 and 45).

Alternatively, or in addition, to the cooling of the cavity region 2e, the front side 3c may be cooled during and/or after creating the cavities 2 by the cooling unit 15a adapted to face the front side 3c (Box 36 or 45). The cooling may be such that a well-defined and uniform front side is provided.

Optionally, a layer 8 may be attached, such as laminated or adhered, to the board element 1 (Box 37 or 44). In some embodiments, as shown in FIGS. 1b, 2b and 2e, a layer 8 may be attached to the substrate 3 while creating the cavities 2 (Box 44). The layer 8 may be a decor structure 8b and/or a backing layer 8e. Preferably, at least an inner portion 2f of the created cavities 2 is supported during attachment of the layer 8 to the board element 1 or substrate (Boxes 35 and 37 or Box 44), cf. FIGS. 1a-1c, 2a-2b, 2e and 6g-6h.

As an alternative or complement to supporting the inner portion 2f during attachment of the layer 8, the substrate portion 3a or the board element 1 may be cooled after creating the cavities 2 and before attaching the layer 8, see, e.g., FIGS. 1a, 1c and 2a.

The board element 1 herein may be provided in the form of a panel 1′ or may dividable into at least one panel 1′, such as at least two panels, wherein each panel is a building panel, floor panel, wall panel, ceiling panel or furniture component. In fact, embodiments of the process disclosed herein (see, e.g., Box 30 or 40) may further comprise dividing the board element 1 into at least one panel, such as at least two panels 1′, by the board dividing device 21a. For example, the board element 1 may be divided into board members 1″ by a first dividing unit 21a′, which in turn may be further divided into at least two panels 1′ by a second dividing unit 21a″, wherein the panels preferably are divided into a substantially final format. Preferably, the board element 1 or board member 1″ is divided while provided above an initial temperature of the substrate 3 and/or an ambient temperature. Any dividing disclosed herein may be implemented by machining, such as by using knives, rotating cutting tools, and similarly.

In some embodiments, the board element 1 is divided into board members 1″ at a dividing portion DP in the form of a separation portion 5b, cf. FIGS. 11g and 12d-12f. Optionally, the board member 1″ may divided into panels 1′ at a dividing portion DP′ in the form of a separation portion 5b′.

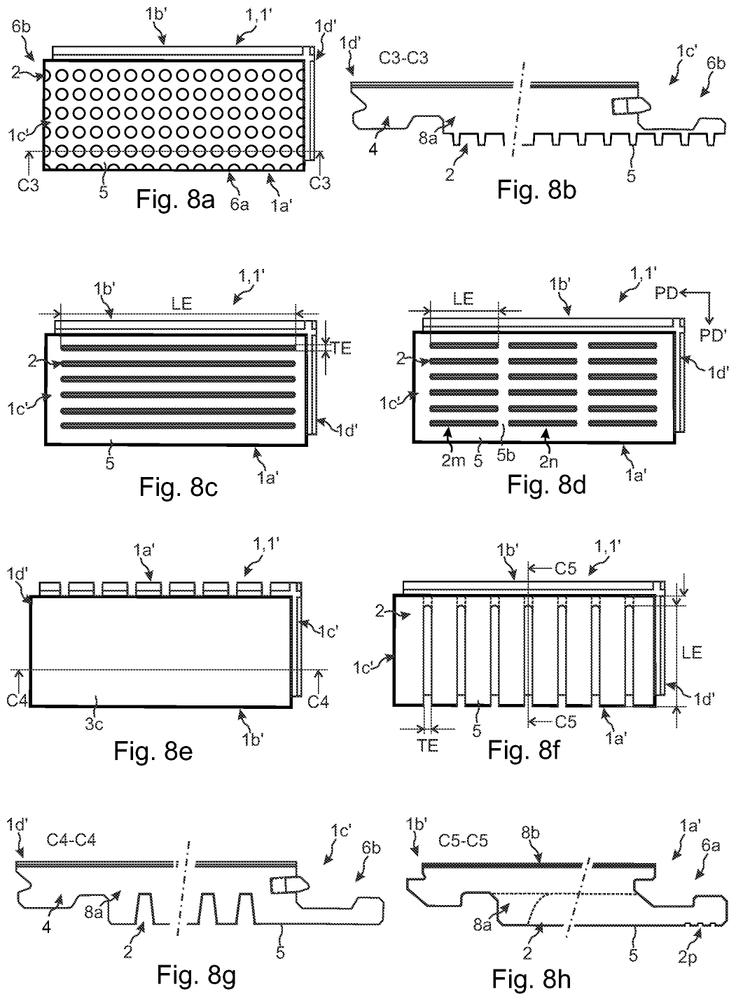

Indeed, in some embodiments, and as shown in, e.g., FIGS. 8d, 11g and 12d-12g, cavities 2 may be created in the board element 1 or panel 1′ that are separated by a separation portion 5b and/or 5b′. A first 2m and a second 2n (or 2n′) group of cavities 2 may be separated from each other along one or two, preferably perpendicular, panel or board directions PD (or PD′) by the separation portion 5b (or preferably forming a continuous segment between opposing edge portions 1a, 1b and/or 1c, 1d (or 1a′, 1b′ and/or 1c′, 1d′ in case of a panel 1′) along the panel or board direction(s) PD and/or PD′. Preferably, the panel or board directions PD and PD′ is a longitudinal LD and a transverse TD direction of the board element or panel, respectively (or vice versa).

As shown in FIGS. 12d-12g, a distance K2 (or K2′) between the cavities 2 along the panel or board direction PD (or PD′) between the first 2m and the second 2n (or 2n′) group may thereby be larger than a distance K1 (or K1′) between the cavities within each of the first and the second groups 2m (or 2n). Moreover, it is stressed that the board element 1, board member 1″, or panel 1′ sometimes may comprise a plurality of such second 2n, 2n′ groups along the panel or board direction(s) PD and/or PD′. Generally herein, a ratio K2/K1 may be at least 3, preferably at least 5, such as at least 10. For example, 3≤K2/K1≤10. Moreover, a ratio K2′/K1′ may be at least 2, preferably at least 5, such as at least 10. For example, 2≤K2′/K1′≤10. In non-limiting examples, K1 (or K1′) may be 1-10 mm, preferably 1-5 mm, more preferably 1.5-4 mm, and K2 (or K2′) may be 5-100 mm, preferably 10-75 mm, more preferably 12-50 mm.

Optionally, one or several of the edge portions 1a-1d of the substrate 3 may be trimmed after creating the cavities 2, such as by cutting with a rotating cutting device or with one or several knives, or by punching. An excess portion if to be trimmed is illustrated in FIG. 12e, which after trimming along a trimming portion TP (see outermost broken lines) may result in edge portions 1a-1d as those shown in, e.g., FIG. 12d. Preferably, the edge portions 1a-1d are trimmed while the substrate 3 is disposed at the elevated temperature TS, cf. the discussion above.

Alternatively, or additionally, the process may further comprise producing a locking device 6a, 6b on at least one edge portion 1a′, 1b′, 1c′, 1d′ by the profiling unit 21b. Preferably, the locking device 6a, 6b is produced on two opposite edge portions of the panel(s) 1′.

The separation portion 5b (or 5b′) may function as a strengthening board area in which no cavities 2 are arranged. Alternatively, it may function as a dividing portion DP (or DP′) of the board element 1, cf. FIGS. 11g and 12d-12f. After dividing the board element, a locking device 6a may be produced at the edge portions 1a′, 1b′ of the panels 1′ by removing board material 1e, such as by machining. Thereby, panels 1′ with edge portions 1a′, 1b′ such as those in any of FIGS. 7b-7d, 7f-7i, 8a, 8c-8f, 8h, 11a or 12g-12h may be obtained. FIGS. 12d-12f illustrate long edge portions 1a′, 1b′, but it is emphasized that similar dividing processes are equally conceivable for dividing the board element 1 and producing a locking device 6b at short edge portions 1c′, 1d′ of a panel 1′, cf. FIGS. 7b-7c, 7e-7f, 7h, 8a-8g, 11b or 12g. A strip 6c′ may extend horizontally beyond an upper portion of the board element 1, and a locking element 6d′ for horizontal locking may be provided thereon.

In some embodiments, the arrangement 20 may further comprise an annealing unit 21c, preferably arranged after at least a part of the board dividing device 21a and before the profiling unit 21b, see, e.g., FIGS. 1a-1c. In a non-restrictive example, and as is most clearly seen in FIG. 1a, the annealing unit 21c may be arranged after the first dividing unit 21a′ and before the second dividing unit 21a″. When the cavity region 2e and/or the front side 3c is cooled by a cooling unit 15 and/or 15a (Box 36 or 45), the annealing preferably is performed after the cooling.

The annealing (Box 38 or 46) may comprise heating the board element 1 or board member 1″ to an annealing temperature of 80-170° C., such as 120-145° C., such as 130-140° C., preferably when the thermoplastic material 4 comprises PVC and a filler 4b, such as an inorganic filler. By way of example, the annealing unit 21c may comprise at least one of a heat oven, a hot-air heater, and a heat bath comprising a fluid, such as water.

FIGS. 6i, 7a-7i, 8a-8h, 10d-10f, 11a-11b, 11g and 12d-12h illustrate further embodiments of a board element 1, such as a panel 1′, obtainable by the process described herein. The board element 1 or panel 1′ comprises at least one layer 8 comprising a thermoplastic material 4 and comprises cavities 2 in a rear side 5. Generally, the board element or panel may be multi-layered, e.g., obtained from co-extrusion or from attaching, such as laminating, layer(s) 8 to a core 8a. For example, the board element or panel may comprise a core 8a and a decor structure 8b, such as a decorative layer 8c and/or a wear layer 8d. The decorative layer and/or wear layer may be provided as a thermoplastic-based foil or film, for example comprising PVC. A thickness of the decorative layer and wear layer may be 0.01-0.10 mm and mm, respectively. In some embodiments, the decor structure 8b may comprise an embossing 3d, see FIGS. 7a-7b. Optionally, the panel may further comprise a backing layer 8e and/or a cover layer 8f, such as a foam layer; also see FIG. 12h. The layer 8 may also be mineral-based layer, cf. the discussion above.

Any, some, or each layer 8, 8a, 8b, 8c, 8d, 8e, 8f may comprise a thermoplastic material 4 comprising thermoplastic polymers 4a, such as PVC, and a filler 4b. Other materials, such as PE, PP, TPU, PET, EVA, PA, PS, PVAc, PMMA, PVB, PC, ABS, PAM,

PBT, or CPVC, are equally conceivable. The filler 4b may comprise, or may be, an inorganic filler, such as a mineral material. Generally herein, the thermoplastic material 4 may further comprise additives 4c, such as at least one of a stabilizer, a blowing agent or a foaming agent, a plasticizer, a colourant, pigments, a lubricant, an impact modifier, a processing aid, etc. For example, a layer 8 of the panel 1, such as the core 8a, e.g., obtainable by embodiments of the process described herein, may comprise 10-40 wt % PVC, 50-90 wt % inorganic filler, such as chalk, and 0-20 wt %, such as 5-20 wt %, additives.

Additives 4c, such as a plasticizer and/or a lubricant, in the thermoplastic material 4 may contribute to an increased flow of the material, such as in the (co-)extruder 16a, and hence a more controlled impression may be obtained. The plasticizer, such as dioctyl terephthalate, DOTP, may soften the thermoplastic material 4. The lubricant may be an internal lubricant, such as fatty alcohols or fatty glycerol esters, and/or an external lubricant, such as wax, e.g., a PE wax or a paraffin wax. For example, a degree of plasticizer may be 1-25 wt %, preferably 3-20 wt %, and/or a degree of lubricant may be 0.2-5 wt % , preferably 1-2 wt %. Moreover, additives 4c, such as a processing aid, may be included for improving the fusion of the thermoplastic material 4 during forming of the substrate 3 and/or for mitigating the formation of cracks during impression. For example, a degree of processing aid, such as an acrylic processing aid, may be 0.5-5 wt %, preferably 1-3 wt %.

In some embodiments, the thermoplastic polymers 4a may comprise a PVC-PVAc copolymer and, optionally PVC. Thereby, the thermoplastic material 4 may become softer and more easily processed, whereby the impression may become simplified. For example, a degree of PVC/PVAc copolymer may be 5-100 wt %, preferably 8-25 wt %.

In any of the embodiments of the substrate 3 or board element 1 or panel 1′ herein, such as in FIGS. 1a-1c, 2a-2f, 3a-3e, 5c-5e, 6g-6i, 7a-7i, 8a-8h, 10b-10f, 11a-11b, 11g and 12d-12h, a surface of an inner portion 2f, such as of the cavity wall 2c and/or the bottom wall 2d, of the cavities 2 may be closed. When the grooves 2g are present, a surface of the inner section 2k of the grooves 2g may be closed. Such a closed surface may be obtained and/or maintained by means of embodiments of the process described herein, whereby the cavities and/or grooves are created by impression, preferably by shaping of a material and/or by displacing material. The closed surface may be formed when forming the substrate 3 under heat and preferably pressure and/or by (co-)extrusion. For example, the closed surface may be included in a crust layer or a skin layer obtained when forming the substrate 3. The closed surface may be maintained when impressing the rear side 3b. For example, the closed surface may extend continuously from the rear side 3b, 5 of the substrate 3 or board element 1, e.g., thereby having essentially no interruptions in a surface integrity. Preferably, the closed surface is non-porous. Thus, such a closed surface may be clearly contrasted with processed or machined surfaces (open surfaces), for example obtained by a rotating cutting device, e.g., as described in WO 2020/180237.

In some embodiments, and as shown, e.g., in FIGS. 7a-7i, 8c-8h, 10d-10e, 11a-11b, 11g and 12d-12h, the cavities 2 may be provided in an interior 5a of the rear side 5, whereby they are spaced from a pair of opposite long edge portions 1a, 1b and/or from a pair of opposite short edge portions 1c, 1d (or 1a′, 1b′ and/or 1c′, 1d′ in the case of a panel 1′). This may be implemented in the process by the space 10f′. Optionally, they are spaced from all edge portions 1a′, 1b′, 1c′, 1d′ of the panel as shown in FIGS. 7c-7e, 8c-8d, 11a-11b, 11g and 12d-12h. The cavities 2 may be provided inside of the locking device(s) 6a and/or 6b, as shown in, e.g., FIGS. 7b-7e, 8c-8d, 8g, 11a-11b and 12f-12h. For example, the cavities 2 may be provided inside of horizontally innermost portions 6e, 6f of the locking device(s) 6a and/or 6b, cf. FIG. 7d-7e.

In some embodiments, as illustrated in, e.g., FIGS. 7a-7i, 8a-8b, 11a-11b, 11g and 12d-12h, a longitudinal LE and a transverse extension TE of the cavities 2 may be substantially the same.

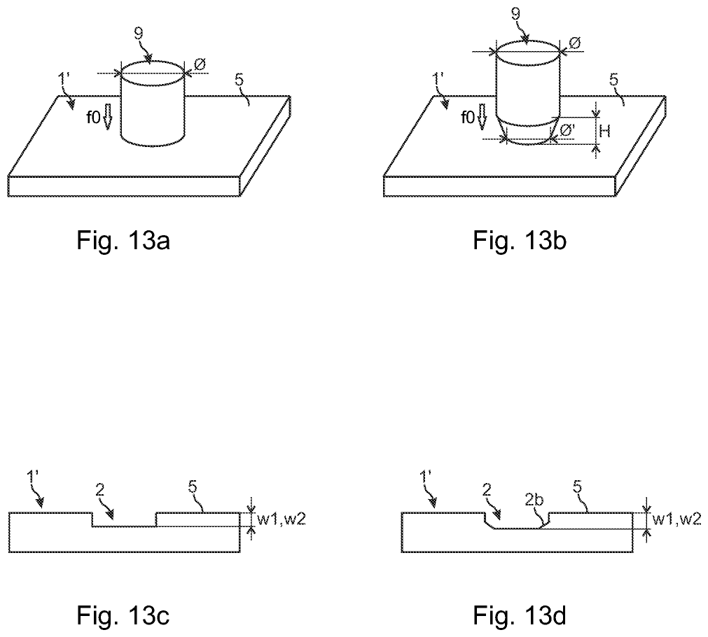

In some embodiments, the impressed cavities 2 may be elongated, whereby the longitudinal extension LE exceeds the transverse extension TE. For instance, the elongated cavities 2 may be created by elongated impression elements 9, e.g., provided on an impression roller 11a or on an impression press plate 12a. As shown in FIGS. 4e-4f, the elongated impression elements 9 may be provided along a part of the base portion 10c, such as along a circumference thereof. In a first example, as shown in, e.g., FIGS. 8c-8d, the longitudinal extension of the cavities 2 may be parallel with the long edge portions 1a, 1b (or 1a′, 1b′) of a board element 1 (or panel 1′). Such elongated cavities (“grooves 10”) are shown, e.g., in FIGS. 13b-13d, 14a-14g and 16e and described, e.g., on page 49, line 25 to page 50, line 4 and lines 18-20, and page 51, line 15 to page 53, line 19 of WO 2020/180237, which parts are explicitly incorporated by reference herein. In a second example, the elongated cavities 2 may be parallel with short edge portions 1c, 1d (or 1c′, 1d′) of the board element 1 (or panel 1′), see, e.g., FIGS. 8e-8h.

In any of the embodiments herein, the elongated cavities 2 may be continuous, as shown, e.g., in FIGS. 8c and 8f, or discontinuous, preferably being separated by a separation portion 5b, 5b′, as shown, e.g., in FIG. 8d.

Generally herein, e.g., in FIGS. 8a-8h, a ratio between the longitudinal LE, LE′ and transverse extensions TE, LE′ of the elongated cavities 2 and/or the elongated impression elements 9 (cf., e.g., FIGS. 4e-4f) may be 1<LE/TE≤150, such as 6≤LE/TE≤120, preferably 10≤LE/TE≤100 (same for LE′/TE′). Any of these ratios is conceivable for cavities 2 that are parallel with long edge portions 1a, 1b (or 1a′, 1b′) or short edge portions 1c, 1d (or 1c′, 1d′). For the impression elements, TE′ and LE′ may be measured along the base portion 10c, such as along the circumference (cf. FIG. 4f).

The cavities 2, for example in any of FIGS. 6h, 7a-7i, 8a-8h, 10d-10f, 11a-11b, 11g and 12d-12h may comprise at least one chamfer 2a, 2b as has been detailed elsewhere herein. Examples of such chamfers provided along the longitudinal LE and/or transverse TE extension(s) are shown in FIGS. 5c and 5e. For example, the chamfers in an elongated cavity 2 may be provided along its longitudinal extension LE and, optionally, along its transverse extension TE. When LE and TE are substantially the same, the chamfer may be provided along an entire circumference 2j of the cavity 2, see, e.g., FIG. 7c and cf. FIGS. 6a-6d.

Alternatively, or additionally, to the chamfer(s) 2a, 2b, the cavities 2 in any of FIGS. 6i, 7a-7i, 8a-8h, 10d-10f, 11a-11b, 11g and 12d-12h may taper by comprising inclined cavity wall(s) 2c along the longitudinal LE and/or transverse TE extension(s) as has been detailed elsewhere herein. Examples of such tapering cavities are shown most clearly in FIGS. 5d, 7d-7e, 7g, 7i, 8b, 8g, 8hand 12h.

The substrate 3 or board element 1, such as the panel 1′, herein may have a, preferably maximal, thickness T of 2-10 mm.

In some embodiments, the cavities 2 may intersect at least a portion of the locking device 6a and/or 6b. For example, the cavities 2 may be open horizontally outwards, such as along a transverse TD and/or longitudinal LD direction of the board element 1. By means of these intersections, parts of the locking device may be impaired along the edge portions. Nevertheless, for many applications the resulting locking strength may be sufficient, especially when the cavities 2 intersect the locking device 6a. Indeed, the long edge portions 1a, 1b have a larger extension and hence, in total, may provide a larger locking portion.

It is emphasized that intersecting cavities 2 may be created by any means, such as by impression or by removing material, for example by a rotating processing device or by carving or scraping, e.g., as described in WO 2020/180237 on page 58, line 26 to page 63, line 6 and FIGS. 1, 17a-17e, and 18a-18b, which parts hereby are explicitly incorporated by reference herein.

The cavities 2 may at least partially intersect the locking device 6a on one long edge portion 1a′ (see FIGS. 7f-7g and FIGS. 8a-8b, 8e-8h, including the curved broken line extending to the rear side 5 in FIG. 8h) or on two long edge portions 1a′, 1b′ (see FIGS. 7h-7i and FIGS. 8e-8h including the horizontal broken line near the long edge portion 1b′ in FIGS. 8f and 8h).

In some embodiments, the locking device 6b may be absent of cavities 2, see, e.g., FIGS. 7c-7i and 8c-8h. For example, the cavities 2 may horizontally intersect a locking device 6a on one long edge portion 1a′ or both long edge portions 1a′, 1b′, as shown in FIGS. 7f-7g and FIGS. 7h-7i, respectively. One long edge portion 1a′ may comprise a strip 6c extending horizontally beyond an upper portion of the panel 1′, and a locking element 6d for horizontal locking may be provided thereon, cf. FIG. 7d.

In some embodiments, the cavities 2 may at least partially intersect the locking device 6b, see, e.g., FIGS. 8a-8b. The cavities 2 may at least partially intersect and/or extend below the locking device 6b on two short edge portions 1c′, 1d′ (see FIGS. 8a-8b), but it is equally conceivable that they at least partially intersect the locking device 6b only on one short edge portion 1c′ or 1d′.

In some embodiments, the depth DC of the cavities 2 may be smaller at the long 1a′, 1b′ and/or short 1c′, 1d′ edge portions than in the interior 5a. The depth DC of the cavities 2 may be smaller at the locking device 6a and/or 6b, for example at the strip 6c, than in the interior 5a, cf. FIGS. 7g, 7i, 8b and 11a-11b. For example, they may become gradually smaller toward the edge portions 1a′, 1b′ and/or 1c′, 1d′, cf. FIGS. 11a-11b.

As shown in FIG. 12h, the panel 1 may in some embodiments comprise a backing layer 8e, preferably being attached, such as laminated, to the core 8a or another layer 8 of the panel. The backing layer 8e may be a balancing layer. The backing layer 8e may be thinner and/or more resilient than the core or layer to which it is attached. A thickness TB1, TB2 of the backing layer preferably is varying. A thickness TB1 at the location of the cavities 2 may be different, preferably smaller, than a thickness TB2 at a location adjacent to and/or between the cavities 2. For example, the varying thickness may be caused by the impression of the cavities, such as by stretching and/or compressing the material in the backing layer. In non-restrictive examples, TB1<0.8*TB2, such as TB1<0.6*TB2. An essentially constant thickness of the backing layer (including TB2=TB1) is however equally conceivable.

The backing layer 8e may be continuous at least at a location of the cavities 2. Preferably, the entire backing layer 8e is continuous, such as shown in FIG. 12h .

### EXAMPLE

A dependency of a degree of impression on temperature variations was tested on a set of sample pairs Q1-Q9 (and Q1′-Q9′) consisting of identical SPC panels (and identical LVT panels), each in the form of a homogeneous core with a density of 2083 kg/m³ and a flexural modulus 8240 N/mm² (and a density of 1948 kg/m³ and a flexural modulus of 1599 N/mm²). The flexural modulus was tested according to ISO 178:2010/A1:2013. Each pair contained two identical samples. Each sample had dimensions 100×100 mm and a thickness of 5 mm.

The samples of each pair were heated to a uniform temperature as specified in Tables 1 and 2. The heated samples in the pairs Q1-Q7 and Q1′-Q7′ were each impressed during about 10 seconds by an impression device comprising a cylindrical impression element having a diameter Ø=8 mm, see FIG. 13a, while the heated samples in the pairs Q8-Q9 and Q8′-Q9′ were impressed by an impression device comprising a tapering impression element, see FIG. 13b, whereby cylindrical and tapering cavities were obtained, respectively, see FIGS. 13c-13d. The tapering impression element comprised a cylindrical inner portion having a diameter Ø=8 mm, and a frustoconical end portion having a height H=2 and an outer disc-shaped region with a diameter Ø′=5 mm. Both impression elements comprised solid tool steel.

Closed surfaces of the rear sides of the two samples in each pair were impressed identically at the same temperature by applying a constant force of f0=98 N on the impression element and against the respective sample, see the test systems in FIGS. 13a-13b. An average degree w0 of impression of the respective sample pair was then determined according to the formula w0=(w1+w2)/2, where w1, w2 were the maximal impression depths measured from the rear side for the respective sample in each pair, see FIGS. 13c-13d and the summaries in Tables 1 and 2. Calipers were used for determining the depths.

TABLE 1
Average impression depths of heated samples

| Temperature (° C.) | Samples | Depth (mm) | Samples | Depth (mm) |
|---|---|---|---|---|
| 40 | Q1 | 0 | Q1′ | 0.04 |
| 60 | Q2 | 0 | Q2′ | 0.09 |
| 100 | Q3 | 0.11 | Q3′ | 0.22 |
| 140 | Q4 | 0.57 | Q4′ | 1.26 |
| 160 | Q5 | 0.78 | Q5′ | 1.72 |
| 180 | Q6 | 1.74 | Q7′ | 3.10 |
| 220 | Q7 | 3.30 | Q7′ | 3.30 |

It may be seen from Tables 1 and 2 that, for a given impression element, the impression depths w0 increased when the sample temperature increased. It may also be concluded that a more substantial degree of impression started at a temperature at or exceeding 100° C.

TABLE 2
Average impression depths of heated samples

| Temperature (° C.) | Samples | Depth (mm) | Samples | Depth (mm) |
|---|---|---|---|---|
| 140 | Q8 | 0.83 | Q8′ | 1.33 |
| 160 | Q9 | 1.03 | Q9′ | 2.30 |

By comparing Table 1 and 2 it may be seen that, for a fixed temperature, the impression depths w0 increased when the tapering impression element was used. It was also found that smoother surface structures were obtained at the impressed rear side. For example, the closed surfaces of the rear sides were maintained to a higher degree. Finally, it was found to be easier to remove the impression elements from the samples in the pairs Q8, Q9, Q8′ and Q9′.

Aspects of the disclosure have mainly been described above with reference to a few embodiments. However, as is readily appreciated by a person skilled in the art, other embodiments than the ones disclosed above are equally possible within the scope of the disclosure. For example, it is stressed that the blank portion 10e and/or 10f may in some embodiments optionally comprise embossing elements 10h, preferably being smaller than the impression elements 9, such as being 50%, preferably 70%, more preferably 90%, smaller than the impression elements in height HS and/or extension, preferably in the horizontal directions E1, E2, see FIGS. 6a-6d and 6f. Such embossing elements 10h would give rise to an embossing structure 2p in the separation portion 5b and/or 5b′, preferably being smaller than the cavities 9, such as being 50%, preferably 70%, more preferably 90%, smaller than the cavities in height DC and/or extension, preferably in the horizontal directions D1, D2 or in the extensions TE, LE, see FIG. 8h .

### EMBODIMENTS

Further aspects of disclosure are provided below. Embodiments, examples etc. of these aspects are largely analogous to the embodiments, examples, etc. as described above, whereby reference is made to the above for a detailed description.

Item 1. Process for manufacturing a board element (1) comprising at least one cavity (2), preferably a plurality of cavities, in a rear side (5) thereof, wherein the process comprises:
providing a substrate (3) comprising a thermoplastic material (4), wherein the substrate comprises a substrate portion (3a), and creating said at least one cavity (2) in a rear side (3b) of the substrate (3) by impressing the substrate portion (3a) by an impression device (10) comprising at least one protruding impression element (9), thereby obtaining said board element (1).

Item 2. The process according to item 1, wherein the impression device (10) comprises at least one roller (11).

Item 3. The process according to item 1, wherein the impression device (10) comprises an impression press plate (12a) provided with a structured surface (12c) comprising said at least one protruding impression element (9).

Item 4. The process according to any of the preceding items, wherein a first (9g) and a second (9h; 9h′) set of impression elements (9) are separated from each other along a separation direction (S1; S2) by a blank portion (10e; 10f), a distance (L2; L2′) between the impression elements along the separation direction (S1; S2) between the first and the second sets being larger than a distance (L1; L1′) between the impression elements within each of the first and the second sets.

Item 5. The process according to any of the preceding items, wherein the substrate portion (3a) is disposed at an elevated temperature (TS) when creating the at least one cavity (2).

Item 6. The process according to item 5, wherein said elevated temperature (TS) is obtained by heating the substrate portion (3a).

Item 7. The process according to item 5, wherein said elevated temperature (TS) is obtained during a forming of the substrate (3) under heat and, preferably, pressure.

Item 8. The process according to any of the preceding items 5-7, wherein the elevated temperature (TS) exceeds 40° C., preferably being 40-295° C., more preferably 100-295° C.

Item 9. The process according to any of the preceding items, wherein said impressing comprises applying a pressure of 0.4-5.0 MPa to the substrate portion (3a).

Item 10. The process according to any of the preceding items, further comprising forming the substrate (3) under heat, preferably under pressure and/or by (co-) extrusion.

Item 11. The process according to any of the preceding items, further comprising cooling at least a cavity region (2e) of the substrate (3) or the board element (1) during and/or after creating the at least one cavity (2).

Item 12. The process according to item 11, wherein said cavity region (2e) is cooled to a cooling temperature (T_{c}) which is within a range of 0.8 to 1.9 of a glass-transition temperature (T_{g}) of the thermoplastic material (4), wherein the cooling temperature (T_{c}) and the glass-transition temperature (T_{g}) are specified in Kelvin.

Item 13. The process according to any of the preceding items, further comprising attaching a layer (8) to the board element (1).

Item 14. The process according to any of the preceding items, further comprising supporting at least an inner portion (2f) of the created at least one cavity (2) during lamination of a layer (8) to the board element (1) and/or during cooling of at least a cavity region (2e) of the board element (1).

Item 15. The process according to item 13 or 14, wherein the layer (8) is a decor structure (8b) and/or a backing layer (8e).

Item 16. The process according to any of the preceding items, further comprising forming at least one chamfer (2a, 2b) in the at least one cavity (2), each chamfer being disposed between a cavity wall (2c) and said rear side (3b; 5) or between the cavity wall (2c) and a bottom wall (2d) of the cavity (2).

Item 17. The process according to any of the preceding items, further comprising creating at least one tapering cavity (2) by means of at least one tapering impression element (9).

Item 18. The process according to any of the preceding items, wherein a draft angle (a) between a lateral wall portion (9c) of the at least one impression element (9) and an overall normal direction (N) of the impression device (10) exceeds 0.5°.

Item 19. The process according to any of the preceding items, further comprising displacing the substrate (3) in a feeding direction (F), preferably during said creating of the at least one cavity.

Item 20. The process according to any of the preceding items, further comprising pre-shaping the substrate (3) before said creating of the at least one cavity (2).

Item 21. The process according to any of the preceding items, wherein the board element (1) is provided in the form of a panel (1′) or is dividable into at least one panel, such as at least two panels, each panel being a building panel, floor panel, wall panel, ceiling panel or furniture component.

Item 22. The process according to any of the preceding items, further comprising annealing the board element (1) after creating the at least one cavity (2).

Item 23. A board element (1), such as a panel (1′), obtainable by the process according to any of the preceding items 1-22.

Item 24. A panel (1′) comprising at least one layer (8) comprising a thermoplastic material (4), wherein the panel comprises at least one cavity (2) in a rear side (5) of the panel, preferably a plurality of cavities.

Item 25. The panel according to item 24, wherein the at least one cavity (2) comprises at least one chamfer (2a, 2b), each chamfer being disposed between a cavity wall (2c) and said rear side (5) or between the cavity wall (2c) and a bottom wall (2d) of the cavity (2).

Item 26. The panel according to item 24 or 25, wherein the at least one cavity (2) taper.

Item 27. The panel according to item 26, wherein a cavity wall (2c) is inclined with respect to a normal direction (M) of the substrate (3) by a wall angle (δ) exceeding 0.5°.

Item 28. The panel according to any of the preceding items 24-27, wherein said at least one cavity (2) is provided in an interior (5a) of the rear side (5) being spaced from a pair of opposite edge portions (1a, 1b; 1c, 1d), such as opposite short edge portions, of the panel, optionally being spaced from all edge portions of the panel.

Item 29. The panel according to any of the preceding items 24-28, wherein the panel is rectangular, and wherein the at least one cavity (2) intersects at least a portion of a locking device (6a; 6b) provided on a long (1a′, 1b′) and/or a short (1c′, 1d′) edge portion of the panel.

Item 30. The panel according to any of the preceding items 24-29, comprising a core (8a) and a decor structure (8b), such as a decorative layer (8c) and/or a wear layer (8d).

Item 31. The panel according to any of the preceding items 24-30, wherein any layer (8; 8a, 8b, 8c, 8d, 8e, 8f), some layers, or each layer comprises a thermoplastic material (4) comprising thermoplastic polymers (4a), such as PVC, and preferably a filler (4b).

Item 32. The panel according to any of the preceding items 24-31, wherein a surface of an inner portion (2f) of the at least one cavity (2) is closed.

Item 33. The panel according to any of the preceding items 24-32, wherein the at least one cavity (2) is elongated, a ratio between longitudinal (LE) and transverse (TE) extensions thereof being 1<LE/TE≤150, such as 6≤LE/TE≤120, preferably 10≤LE/TE≤100.

Item 34. The panel according to any of the preceding items 24-33, wherein the at least one cavity (2) has an extension along a pair of non-parallel, such as perpendicular, horizontal directions (D1, D2) that are substantially the same.

Item 35. The panel according to any of the preceding items 24-34, wherein a depth (DC) of a plurality of cavities (2) is smaller at long (1a′, 1b′) and/or short (1c′, 1d′) edge portions of the panel than in an interior (5a) of the rear side (5).

Item 36. The panel according to any of the preceding items 24-35, wherein a first (2m) and a second (2n; 2n′) group of cavities (2) are separated from each other along a panel direction (PD; PD′) by a separation portion (5b; 5b′), a distance (K2; K2′) between the cavities along the panel direction (PD; PD′) between the first and the second group being larger than a distance (K1; K1′) between the cavities within each of the first and the second groups.

Item 37. The panel according to any of the preceding items 24-36, further comprising a backing layer (8e), wherein the backing layer is continuous at least at a location of said at least one cavity (2).

Item 38. Process for manufacturing a board element (1) comprising at least one cavity (2), preferably a plurality of cavities, in a rear side (5) thereof, wherein the process comprises:
providing a substrate (3) comprising a thermoplastic material (4), wherein the substrate comprises a substrate portion (3a),
creating said at least one cavity (2) in a rear side (3b) of the substrate (3) by impressing the substrate portion (3a) by an impression device (10) comprising at least one protruding impression element (9), thereby obtaining said board element (1), and
   annealing the board element (1) after creating the at least one cavity (2).

Item 39. The process according to item 38 and according to any of the preceding items 2-21.

Item 40. Process for manufacturing a board element (1) comprising a plurality of cavities in a rear side (5) thereof, wherein the process comprises:
providing a substrate (3) comprising a thermoplastic material (4), wherein the substrate comprises a substrate portion (3a), and
creating said cavities (2) in a rear side (3b) of the substrate (3) by impressing the substrate portion (3a) by an impression device (10) comprising at least one protruding impression element (9), thereby obtaining said board element (1),
   wherein a first (9g) and a second (9h; 9h′) set of impression elements (9) are separated from each other along a separation direction (S1; S2) by a blank portion (10e; 10f), a distance (L2; L2′) between the impression elements along the separation direction (S1; S2) between the first and the second sets being larger than a distance (L1; L1′) between the impression elements within each of the first and the second sets,
   such that a first (2m) and a second (2n; 2n′) group of cavities (2) are created that are separated from each other along a panel or board direction (PD; PD′) by a separation portion (5b; 5b′), a distance (K2; K2′) between the cavities along the panel or board direction (PD; PD′) between the first and the second group being larger than a distance (K1; K1′) between the cavities within each of the first and the second groups.

Item 41. The process according to item 40 and according to any of the preceding items 2-22.

1. Process for manufacturing a board element comprising at least one cavity in a rear side thereof, wherein the process comprises:
providing a substrate comprising a thermoplastic material, wherein the substrate comprises a substrate portion, and
creating said at least one cavity in a rear side of the substrate by impressing the substrate portion by an impression device comprising at least one protruding impression element, thereby obtaining said board element,
wherein the substrate portion is disposed at an elevated temperature (TS) when creating the at least one cavity, the elevated temperature (TS) being 40-295° C., and
wherein the at least one protruding impression element is a tapering impression element, and wherein the tapering impression element creates a tapering cavity.

2. The process according to claim 1, wherein a draft angle between a lateral wall portion of the at least one tapering impression element and an overall normal direction of the impression device exceeds 0.5°.

3. The process according to claim 1, wherein the tapering impression element comprises a tapering lateral wall portion and/or a bevel, and the tapering cavity comprises a tapering cavity wall and/or a chamfer.

4. The process according to claim 1, further comprising forming at least one chamfer in the at least one tapering cavity, each chamfer being disposed between a cavity wall and said rear side or between the cavity wall and a bottom wall of the tapering cavity.

5. The process according to claim 1, wherein the impression device comprises at least one roller.

6. The process according to claim 1, wherein the impression device comprises an impression press plate provided with a structured surface comprising said at least one protruding impression element.

7. The process according to claim 1, wherein the elevated temperature is in the range of 100-295° C.

8. The process according to claim 1, wherein said elevated temperature is obtained by heating the substrate portion.

9. The process according to claim 8, wherein said elevated temperature is obtained during a forming of the substrate under heat and, optionally, pressure.

10. The process according to claim 1, wherein said impressing comprises applying a pressure of 0.4-5.0 MPa to the substrate portion.

11. The process according to claim 1, further comprising cooling at least a cavity region of the substrate or the board element during and/or after creating the at least one cavity.

12. The process according to claim 11, wherein said cavity region is cooled to a cooling temperature which is within a range of 0.8 to 1.9 of a glass-transition temperature of the thermoplastic material, wherein the cooling temperature and the glass-transition temperature are specified in Kelvin.

13. The process according to claim 1, further comprising supporting at least an inner portion of the created at least one cavity during lamination of a layer to the board element and/or during cooling of at least a cavity region of the board element.

14. The process according to claim 1, further comprising pre-shaping the substrate before said creating of the at least one cavity.

15. The process according to claim 1, wherein the board element is provided in the form of a panel or is dividable into at least one panel, such as at least two panels, each panel being a building panel, floor panel, wall panel, ceiling panel or furniture component.
